(19) United States
(12) Patent Application Publication
(10) Pub. No.: US 2008/0115081 A1
(43) Pub. Date: May 15, 2008

(54) Enhanced windows management feature

(75) Inventors: Srinivasa M. Sankaravadivelu, Redmond, WA (US); Scott Mitchel Mail, Seattle, WA (US); Jianying Wang, Issaquah, WA (US); Sarah Fuelling, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/595,122

(22) Filed: Nov. 9, 2006

(51) Int. Cl. G06F 3/048

(52) U.S. Cl. 715/783

(57) ABSTRACT

An enhanced windows management feature provides computing device users with the ability to view open windows simultaneously and unobscured on the computing device display. User satisfaction is increased when a user can cause all windows open on a computing device display to be exhibited simultaneously and unobscured with quick and easy user actions. The enhanced windows management feature allows a user to work within the display of all open windows to, e.g., minimize, maximize or close open windows, or change the z-order of the open windows when normally exhibited on the computing device display. The enhanced windows management feature also allows a user to view and work within, at the same time, two or more live, i.e., active, windows that are displayed simultaneously and unobscured on the computing device display.

### BACKGROUND

Using computers and computer-based devices that support more than one open, i.e., activated, application at a time, collectively referred to herein as computing devices, users can have more than one application and/or more than one instance of a particular application open at any given time. In many common computing devices, applications are open into a window that appears on the computing device display, e.g., monitor or screen, and from which the user can interact with the application. For example, a user can have a word processing application, e.g., MICROSOFT WORD™, open in a window for creating or editing a document. A user can also, or alternatively, have an internet access application, e.g., MICROSOFT INTERNET EXPLORER™, open for viewing one or more web pages. A drawing application, e.g., MICROSOFT VISIO™, may also, or alternatively, be opened by a user into a window exhibited on the user's computing device display for creating a graphics file.

Computing devices can support multiple windows, i.e., multiple applications open into respective windows, at any given time. However, it is currently generally inefficient for a user to ascertain which of multiple applications are open, or to identify a particular desired window from a plethora of currently activated, i.e., open, ones.

For example, if some or all of the open windows are maximized then a percentage of these maximized windows are hidden, or at least partially obscured, by other windows. If a user tries to resize the various open windows to view them all simultaneously and unobscured this takes many user manipulations with a computing device input device, e.g., a mouse, to attempt to reformat the various windows' dimensions. Moreover, once a desired window from the various open ones is located it must often be resized yet again for it to be of useful dimensions to the user. And if there are many currently active windows the enormity of the task of resizing all of them in order to view them all unobscured simultaneously may prove too daunting for the average user, and simply too much effort for any user, novice, average or skilled.

A user may, alternatively, currently ascertain which windows are open, i.e., applications are enabled and activated, by referring to the Taskbar output on their computing device display. In at least some cases, a Taskbar is displayed on the bottom of the computing device screen, or monitor, and indicates the currently open windows by various respective buttons. However, Taskbar buttons are generally physically small entities to view and acquire. Moreover, Taskbar buttons fail to display visually descriptive information about what the respective windows actually look like, or contain, and only allow users to locate a particular window via a small application icon, or symbol, and some truncated label.

For example, a word processing application Taskbar button fails to show what is currently in the word processing application window, i.e., the contents of the document being created or edited. And a Taskbar button generally fails to display the entire name of the application open in the respective window. For example, a Taskbar button for a fictional document titled EXAMDOCUMT being created with the MICROSOFT WORD™ word processing application may likely show the icon for MICROSOFT WORD™ followed by the document title and a truncated version of the application MICROSOFT WORD™—e.g., EXAMDOCUMT—Micros . . .

The meager information identified in various Taskbar buttons is generally of limited use to a user in and of itself. Users must routinely click multiple Taskbar buttons to maximize the associated windows and ascertain their contents in order to locate a particular desired application when more than one application is activated at a time. When many windows are open at once and/or two or more windows support various instances of the same application, e.g., two or more windows support respective instances of a word processing application activated for different documents, user frustration can occur in trying to locate the exact desired window among the many available alternatives.

Another known alternative for a user to ascertain which windows are open, i.e., applications are activated on their computing device at any given time, is an Alt-Tab feature supported by some computing devices. Pressing the “Alt” key on a keyboard associated with the computing device simultaneously with pressing the “Tab” keyboard key causes a small window to be exhibited on the computing device display which shows the icons of the open windows, i.e., applications open in the respective windows that are currently enabled and activated on the computing device. The scant information displayed with the Alt-Tab feature about the various open windows on the computing device suffers however from the same deficiencies as the Taskbar solution. Moreover, many users, especially those that generally rely on inputting commands via alternative measures than keystrokes, such as, but not limited to, mouse clicks, may be unaware of the Alt-Tab feature.

There is, therefore, scenarios where an enhanced windows management feature that allows a user to view multiple unobscured windows activated on their computing device at one time without the need for many cumbersome user manipulations, and which is generally easily discoverable to an average user, would create efficiencies and user benefit, as well as enhance the user computing device experience.

### SUMMARY

This summary is provided to introduce a selection of concepts in a simplified form that are further described below in the Detailed Description. This summary is not intended to identify key or essential features of the claimed subject matter, nor is it intended to be used as an aid in determining the scope of the claimed subject matter.

Embodiments discussed herein include technology that provides for a quick, easy method for a computing device user to view all open windows on their computing device simultaneously and unobscured.

In an embodiment a simple user action causes snapshots of all open windows on a computing device to be displayed simultaneously and unobscured. In an embodiment other simple user actions are supported for a user to perform various actions on the display of open window snapshots, such as, but not limited to, bringing a new open window to the computing device display foreground, minimizing the open windows, and closing one or more open windows.

In another embodiment a simple user action causes live views of at least some open windows on a computing device, i.e., the actual window rather than a snapshot in time of the respective window, to be displayed with snapshots of other open windows simultaneously and unobscured.

Embodiments discussed herein also include technology that allows for a user to work within two or more windows that are displayed simultaneously and unobscured on the computing device display.

### BRIEF DESCRIPTION OF THE DRAWINGS

These and other features will now be described with reference to the drawings of certain embodiments and examples which are intended to illustrate and not to limit the invention, and in which:

FIGS. 1A and 1B are exemplary computing device displays exhibiting various open windows hosting various activated applications.

FIG. 1C depicts an embodiment windows management feature grid displaying all the open windows of the computing device displays of FIGS. 1A and 1B simultaneously and unobscured.

FIG. 2A depicts an embodiment windows management feature grid layout for one open window.

FIG. 2B depicts embodiment windows management feature grid layouts for two, three and four open windows.

FIG. 2C depicts embodiment windows management feature grid layouts for five to six and seven to nine open windows.

FIG. 3 depicts an embodiment computing device three-button mouse.

FIG. 4A depicts an exemplary computing device display after an embodiment windows management feature grid is toggled off and a different open window is positioned in the foreground from the one that was in the foreground prior to the embodiment windows management feature grid being enabled.

FIG. 4B depicts an exemplary computing device display after an embodiment windows management feature is toggled off and all open windows are minimized.

FIG. 5A depicts an exemplary computing device display exhibiting a windows management feature grid redrawn to reflect an open window having been closed.

FIG. 5B depicts an exemplary computing device display after the embodiment windows management feature grid of FIG. 5A is toggled off.

FIG. 5C depicts an exemplary computing device display with one open maximized window and three open minimized windows.

FIG. 6 depicts an exemplary computing device display exhibiting a windows management feature grid and Taskbar buttons for the open windows, wherein one Taskbar button is a grouped windows Taskbar button.

FIG. 7A depicts an exemplary computing device display for an embodiment windows management feature supporting cell compare buttons.

FIG. 7B depicts an exemplary computing device display for an embodiment windows management feature supporting various cell action buttons.

FIG. 8A depicts an exemplary computing device display where windows selected for a windows compare action are positioned horizontally on the computing device display.

FIG. 8B depicts an exemplary computing device display where windows selected for a windows compare action are positioned vertically on the computing device display.

FIG. 9 depicts an exemplary embodiment windows management feature grid after the corresponding computing device monitor has been reoriented ninety degrees.

FIGS. 10A-10F illustrate an embodiment logic flow for a methodology for an embodiment windows management feature.

FIG. 11 is a block diagram of an exemplary basic computing device system that can process software, i.e., program code, or instructions.

### DETAILED DESCRIPTION

In the following description, for purposes of explanation, numerous specific details are set forth in order to provide a thorough understanding of the present invention. It will be apparent, however, to one skilled in the art that the invention may be practiced without these specific details. In other instances, well-known structures and devices are shown in block diagram form in order to avoid unnecessarily obscuring the invention. Any and all titles used throughout are for ease of explanation only and are not for use in limiting the invention.

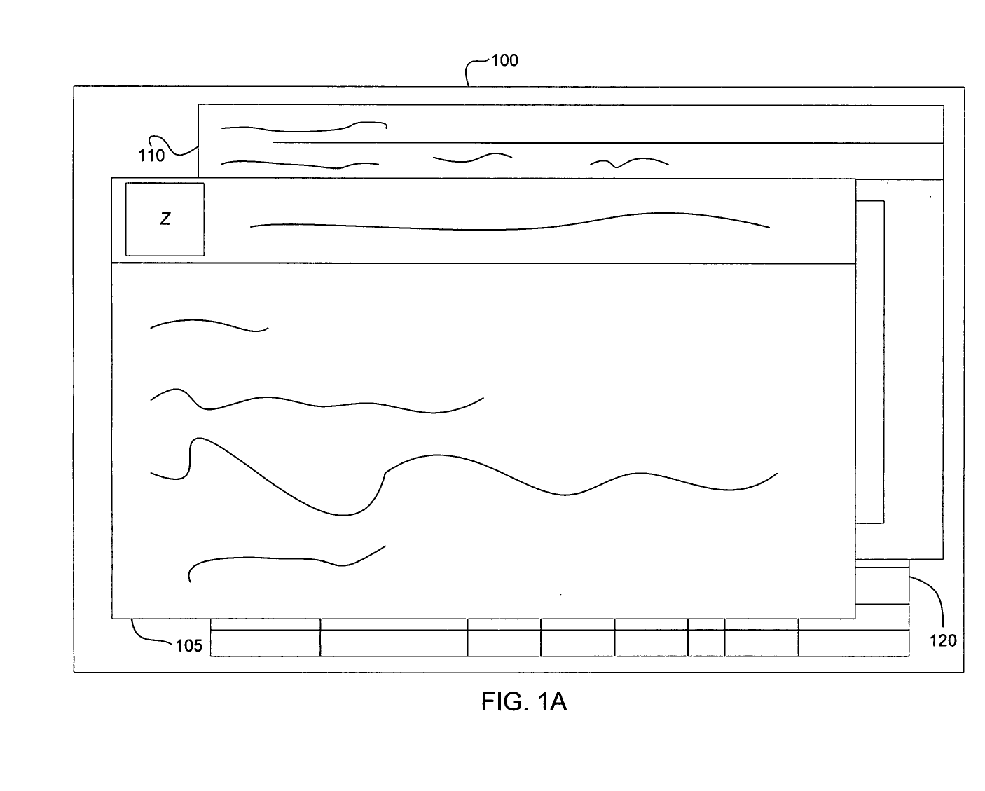

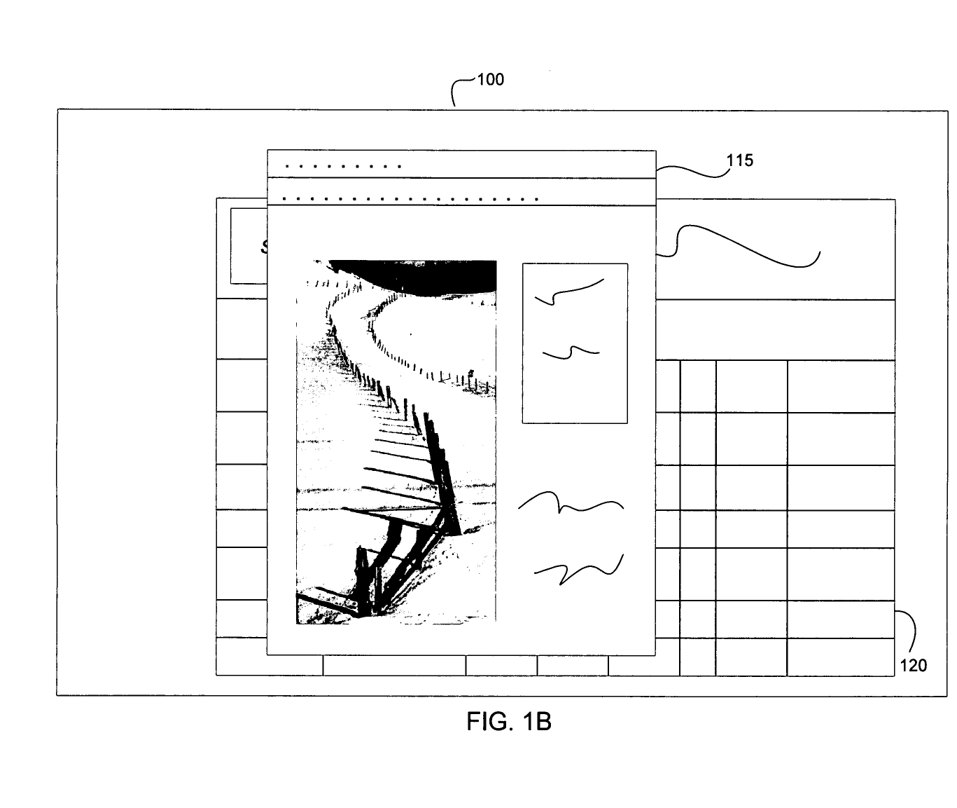

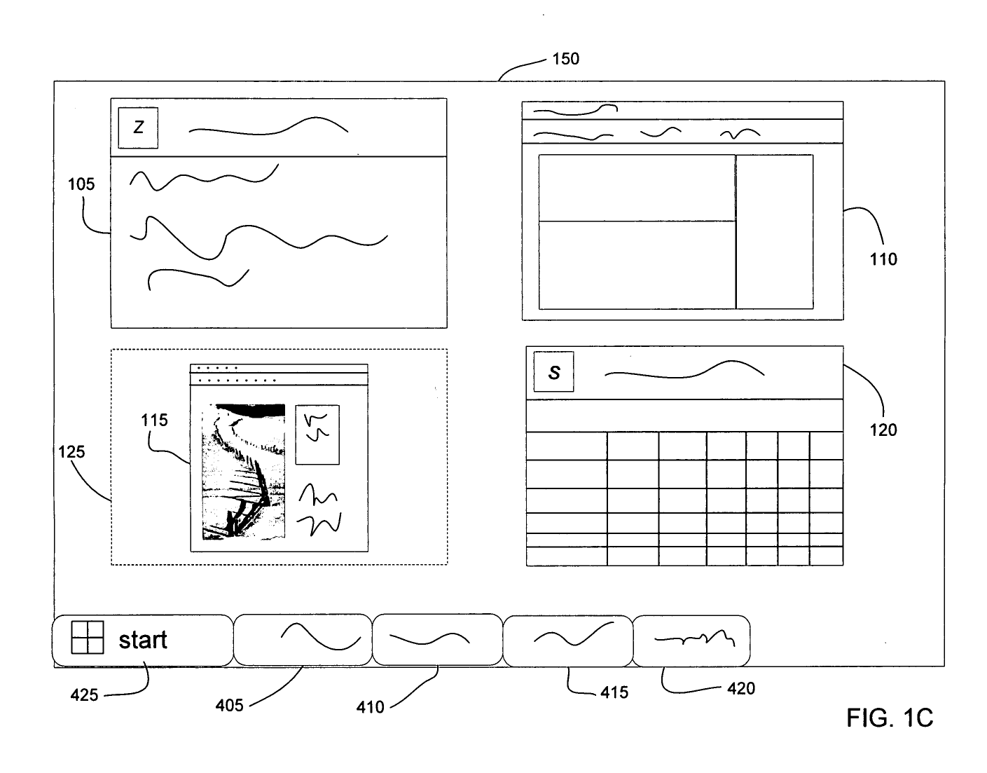

FIG. 1A shows an exemplary computing device display, e.g., screen, 100 in which there are four (4) open, maximized windows, wherein each of the four open windows hosts a separate enabled application or application instance. The first application a user enabled on the computing device was a spread sheet application that the user accesses via window 120.

The second application that a user enabled on the same computing device while the first application was still enabled and its associated window 120 was still maximized was an internet access application wherein the user accesses a current first web page via window 115, shown in FIG. 1B. Window 115 cannot be seen on the computing device display 100 of FIG. 1A because it is completely obscured by windows 110 and 105 as further explained below. As can be seen in FIG. 1B however, window 115 is situated in front of window 120 in the z-plane of the computing device display 100 as the internet access application used to access the current first web page displayed in window 115 was enabled after, i.e., more recently than, the spread-sheet application accessible via window 120 and/or the application hosted by window 115 was accessed by the user more recently than the application hosted by window 120.

The third application that a user enabled on the same computing device while the first and second applications were still enabled and their associated windows 120 and 115 were still maximized was a second instance of the internet access application wherein the user accesses a current second web page via window 110. Window 110 is positioned in front of window 115 in the z-plane of the computing device display 100 as the second instance of the internet access application hosting the current second web page displayed in window 110 was enabled after the first instance of the internet access application hosting the current first web page displayed in window 115 and/or the second instance of the internet access application hosted by window 110 was accessed by the user more recently than the first instance of the internet access application hosted by window 115. Window 110 is likewise situated in front of window 120 in the z-plane of the computing device display 100 as shown in FIG. 1A.

In the example computing device display 100 of FIG. 1A window 110, along with window 105, completely obscures window 115. In this example window 115 is hidden behind windows 110 and 105 as it is situated in the z-plane behind both windows 110 and 105 and because in this example the user has manipulated the x-y dimensions of window 115 so that window 115 is now smaller than when it was first activated. The smaller x-y dimensions of window 115 result in window 115 being completely concealed by windows 110 and 105 in the exemplary computing device display 100 of FIG. 1A.

The fourth, and last in the current example, application that a user enabled on the same computing device while the first application and first and second instances of the second application were still enabled and their associated windows 120, 115 and 110 remain maximized is a word processing application that the user accesses via window 105.

Window 105 is situated in front of windows 110, 115 and 120 in the z-plane of the computing device display 100 of FIG. 1A as the word processing application was enabled after any of the applications or application instances hosted by windows 110, 115 and 120 and/or the word processing application hosted by window 105 was accessed by the user more recently than any of the applications or application instances hosted by windows 110, 115 and 120.

A result of an exemplary use of an embodiment enhanced windows management feature for simultaneously creating unobscured views of multiple open windows on a computing device. i.e., an embodiment windows management feature, is depicted in FIG. 1C. FIG. 1C shows exemplary computing device display 150 exhibiting views of the four windows 105, 110, 115 and 120 of FIGS. 1A and 1B all unobscured. In the example of FIG. 1C views of the four windows 105, 110, 115 and 120 currently open on the computing device are displayed in various cells in a grid where each open window has the same cell dimensions available to it. Thus, in an embodiment the view of each open window displayed with the windows management feature is afforded the same proportional space allocation on the computing device display 150.

In an embodiment the amount of proportional space allocated to a window view displayed with an embodiment windows management feature, i.e., the cell size, is determined by the number of windows to be displayed, i.e., the number of active, enabled windows on the computing device, taking into account the current computing device display resolution and aspect ratio, with a goal being to display each window view with the largest dimensions possible. Thus, in an embodiment the less number of open windows that exist at the time the windows management feature is activated, the greater the amount of proportional space allocated to each displayed window view.

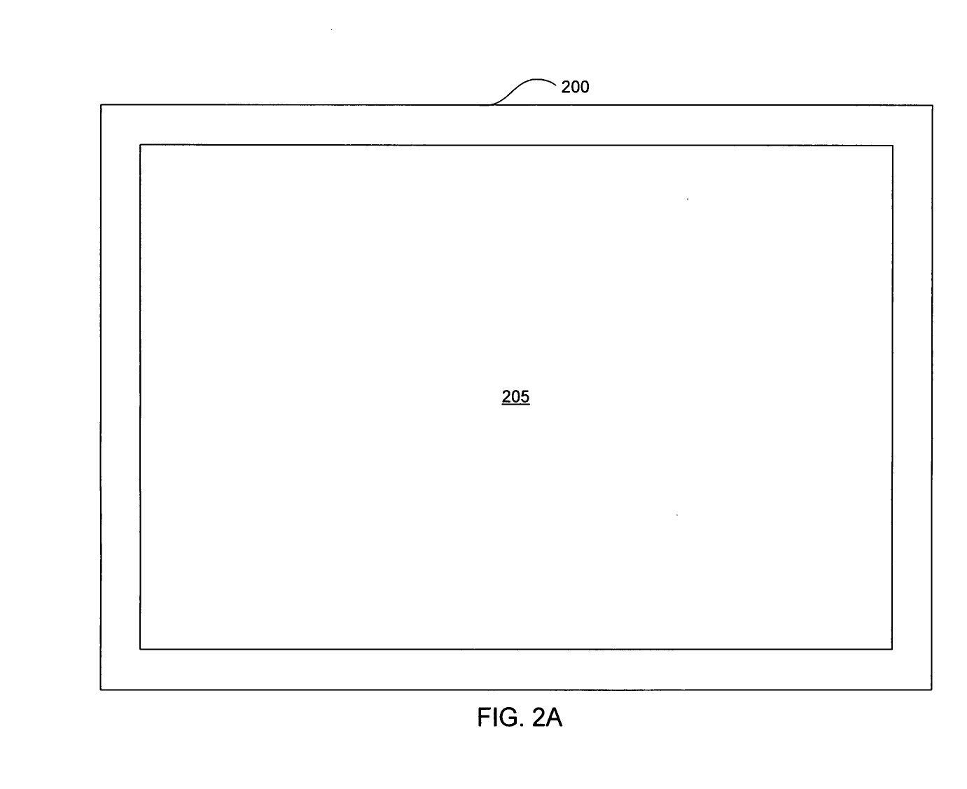

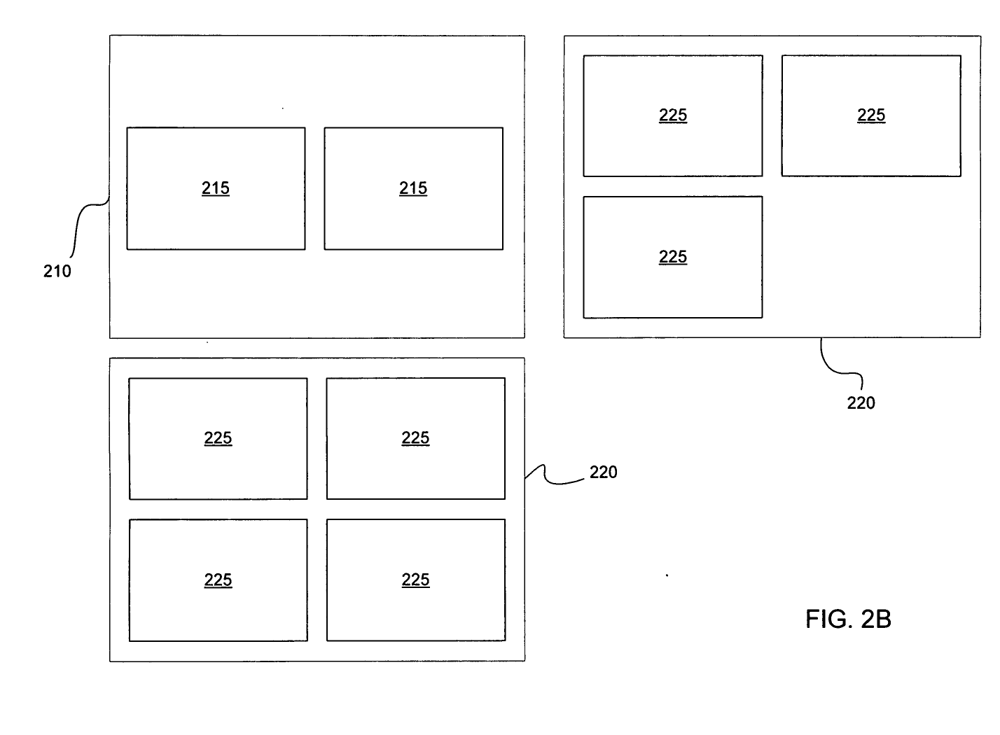

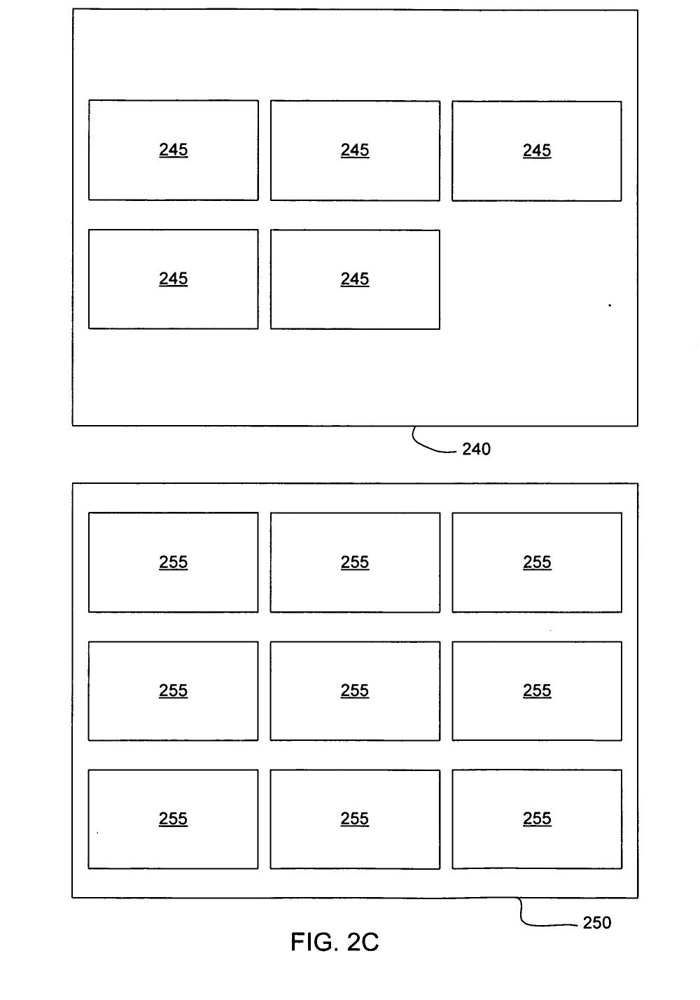

Referring to FIG. 2A, in an embodiment if there is only one open window when the windows management feature is activated, a view of the one open window is displayed in a cell 205 of a one-cell grid centered vertically and horizontally on the computing device display 200.

In an alternative embodiment, and referring to FIG. 2B, if there is only one open window when the windows management feature is activated a view of the one open window is displayed in one cell 215 of a two-cell grid composed of two columns and one row that are centered vertically and horizontally on the computing device display 210. In this alternative embodiment the view of the one open window is displayed in the left cell 215 while the right cell 215 remains empty. Using a two-cell grid for displaying the view of one open window in this alternative embodiment may help a user to recognize that the windows management feature has been activated.

In an embodiment, if there are two open windows when the windows management feature is activated a view of each of the two open windows is displayed in a respective cell 215 of a two-cell grid composed of two columns and one row that are centered vertically and horizontally on the computing device display 210 as shown in FIG. 2B.

In an embodiment if there are three or four open windows when the windows management feature is activated, a view of each open window is displayed in a respective cell 225 of a four-cell grid of two columns and two rows that are centered vertically and horizontally on the computing device display 220.

In an embodiment, whether there are two, three or four open windows when the windows management feature is activated, each window view is displayed in a cell of the same size in the grid. Thus, in this embodiment cells 215 are the same size as cells 225.

Referring to FIG. 2C, in an embodiment if there are five or six open windows when the windows management feature is activated, a view of each open window is displayed in a respective cell 245 of a six-cell grid composed of three columns and two rows that are centered vertically and horizontally on the computing device display 240. In the example computing device display 240 of FIG. 2C five open windows existed at the time the embodiment windows management feature was activated.

In an embodiment if there are seven, eight or nine open windows when the windows management feature is activated, a view of each open window is displayed in a respective cell 255 of a nine-cell grid with three columns and three rows that are centered vertically and horizontally on the computing device display 250. In the example computing device display 250 of FIG. 2C nine open windows existed at the time the embodiment windows management feature was activated.

In an embodiment, whether there are five, six, seven, eight or nine open windows when the windows management feature is activated, a view of each window is displayed in the same size cell of the grid. Thus, in this embodiment cells 245 are the same size as cells 255.

Following the same mathematical pattern, in an embodiment if there are ten to twelve open windows when the windows management feature is activated, a view of each open window is displayed in a respective cell of a twelve-cell grid composed of four columns and three rows that are centered vertically and horizontally on the computing device display. Likewise, in an embodiment if there are thirteen to sixteen open windows when the windows management feature is activated, a view of each open window is displayed in a respective cell of a sixteen-cell grid with four columns and four rows that are centered vertically and horizontally on the computing device display. In an embodiment, whether there are ten, eleven, twelve, thirteen, fourteen, fifteen or sixteen open windows when the windows management feature is activated, a view of each window is displayed in a cell of the same size in the grid.

In this embodiment a column is added first, and then a row, to the grid for accommodating the display of all the open windows when the windows management feature is activated. In this embodiment, the cell size of the grid is altered each time a new column is added to the grid for accommodating the display of all the open windows.

In an embodiment the number of open windows that can simultaneously be displayed unobscured with a windows management feature is unlimited. However, practically speaking, the number of open windows that can simultaneously be displayed unobscured with the windows management feature and be identifiable by a user is limited by the computing device display size and resolution. For example, the size of the grid, i.e., the number of cells of the grid necessary to display views of all the currently open windows, may result in the open window views displayed on the computing device display, e.g., screen, being too small for effective user viewing and use. Similarly, the size of the grid necessary to display views of all the currently open windows may result in the open window views displayed on the computing device display, e.g., screen, being too unfocused, or blurry, for effective user viewing and use.

In alternative embodiments proportional space allocations, i.e., cell sizes, for open windows are allocated based on different criteria. For example, in one alternative embodiment the cell size allocated to each open window is determined by the unique number of open windows to be displayed. In this alternative embodiment the cell size for one open window is different than for two open windows, which is different than for three open windows, which is different than for four open windows, and so on.

Alternative embodiments employ different grid formations. For example, in one alternative embodiment, a row is added, then a column, to accommodate the display of all the open windows when the windows management feature is activated. In this alternative embodiment, when there are two open windows, views of the windows are displayed in a two row, one column grid in which the window views are vertically, rather than horizontally, aligned.

In an embodiment the grid generated by the windows management feature respects the aspect ratio of the computing device display's screen resolution and adjusts the cell layout accordingly. Thus for example, if the computing device display has a four:three (4:3) aspect ratio screen resolution the embodiment windows management feature generates a grid with cells having the same four:three (4:3) aspect ratio.

In an embodiment if there is a global setting for display orientation for the computing device display the windows management feature respects this global setting in generating the grid for exhibiting views of all open windows simultaneously.

An embodiment windows management feature establishes a grid margin that is equal to two percent (2%) of the current computing device display resolution width. In alternative embodiments other grid margins are used.

In an embodiment the windows management feature establishes twenty-two (22) pixels for a cell top margin and thirty (30) pixels for a cell bottom margin. In this embodiment the windows management feature uses the aspect ratio of the computing device display and the space between the cell top and bottom margins to establish cell left and right margins.

In alternative embodiments other criteria and/or values are used for establishing the various cell margins.

In an embodiment views of the windows displayed with the windows management feature are proportionally scaled in order that they fit within their assigned cell. In this embodiment a view of an open window is displayed with the windows management feature in its allocated grid cell on the computing device display with the same relative proportions as the window has when it is normally displayed on the computing device display. For purposes of this embodiment a window is normally displayed on a computing device display when it is open and accessible to a user and exhibited on the computing device display before any embodiment windows management feature grid is activated. For example, when a user opens a word processing program the window from which the user accesses the word processing program to create and/or edit a document is normally displayed on the computing device display. As another example, once a user opens an application, e.g., a web browser, or internet access application, if the user manually resizes the window from which they are viewing a web page, the newly resized window is deemed the window normally displayed on the computing device display for the web browser application instance.

Referring back to FIG. 1C, there are currently four open windows, 105, 110, 115 and 120, that are simultaneously displayed, unobscured, with an embodiment windows management feature. Each of these four open windows is assigned a grid cell that, in an embodiment, each has the same size. Three of the four open windows 105, 110 and 120 are full size windows when displayed normally on the computing device display 100, as shown in FIGS. 1A and 1B, and thus, views of these three windows 105, 110 and 120 are displayed in their entire allocated cell space when exhibited in a grid of an embodiment windows management feature.

Views of each of windows 105, 110 and 120, have however been proportionally scaled in order that they conform to their assigned cell size. Thus, while the views of each of windows 105, 110 and 120 exhibited in FIG. 1C are smaller than their corresponding windows 105, 110 and 120 exhibited in FIG. 1A, the views of windows 105, 110 and 120 displayed in FIG. 1C retain the same proportional x-y dimensions as their respective windows displayed in FIG. 1A. For example, assume that the cells of the grid displayed in FIG. 1C can accommodate a window view that is one quarter (0.25) the size of the normally displayed window in FIG. 1A and assume that window 105 displayed in FIG. 1A has an x-dimension of one hundred and sixty (160) pixels and a y-dimension of one hundred and twenty (120) pixels. In this example, the view of window 105 exhibited in its respective grid cell of FIG. 1C will have an x-dimension of forty (40) pixels and a y-dimension of thirty (30) pixels, which is proportionally one quarter (0.25) the size of the normally displayed window 105 of FIG. 1A.

Window 115 is smaller than a full size window when it is normally displayed on the computing device display 100 of FIG. 1B because, as previously explained, in the example of FIGS. 1A and 1B the user has altered the x-y dimensions of window 115 which has resulted in window 115 being smaller than when it was originally activated. Thus, in an embodiment, while window 115 is allocated the same cell size as each of the other three open windows, 105, 110 and 120 from FIGS. 1A and 1B, the view of window 115 does not occupy the entire allocated cell space 125 when exhibited in a grid of an embodiment windows management feature.

Like the views of windows 105, 110 and 115 displayed in FIG. 1C, in an embodiment the view of window 115 assumes the same proportional allocated cell space 125 as window 115 occupies when normally displayed on the computing device display 100 of FIG. 1B. Thus, the view of window 115 in FIG. 1C has the same proportional x-y dimensions in cell 125 as window 115 has on the computing device display 100 of FIG. 1B.

In an embodiment the view of each open window displayed in a grid with the windows management feature is centered vertically and horizontally within its respective grid cell.

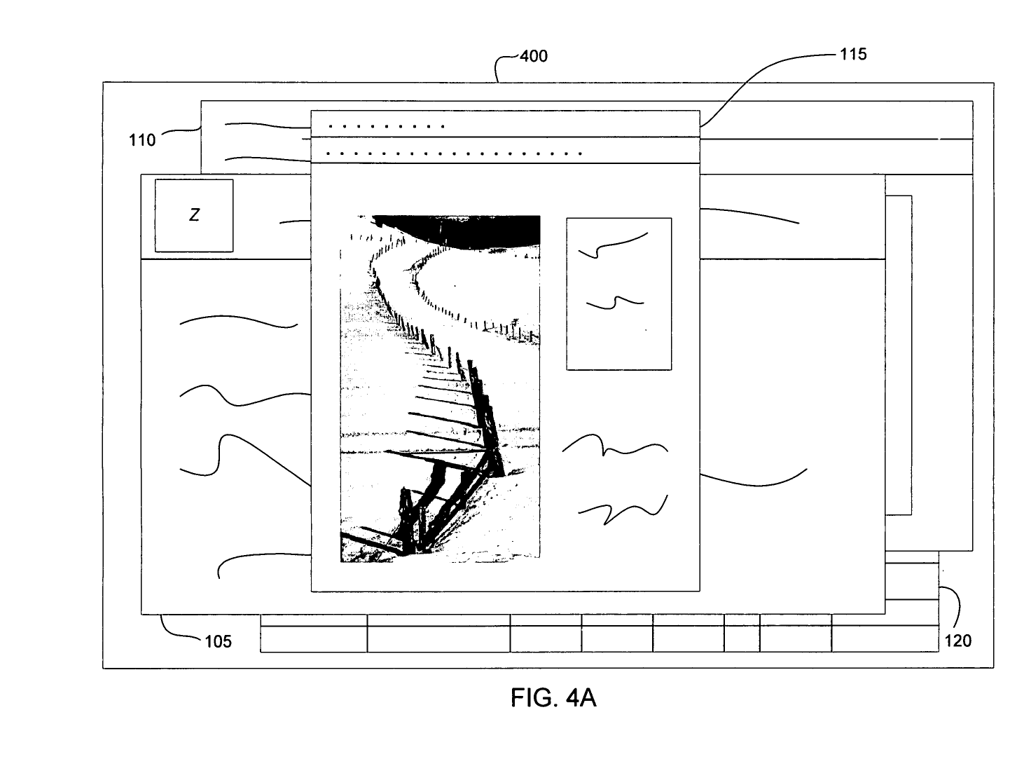

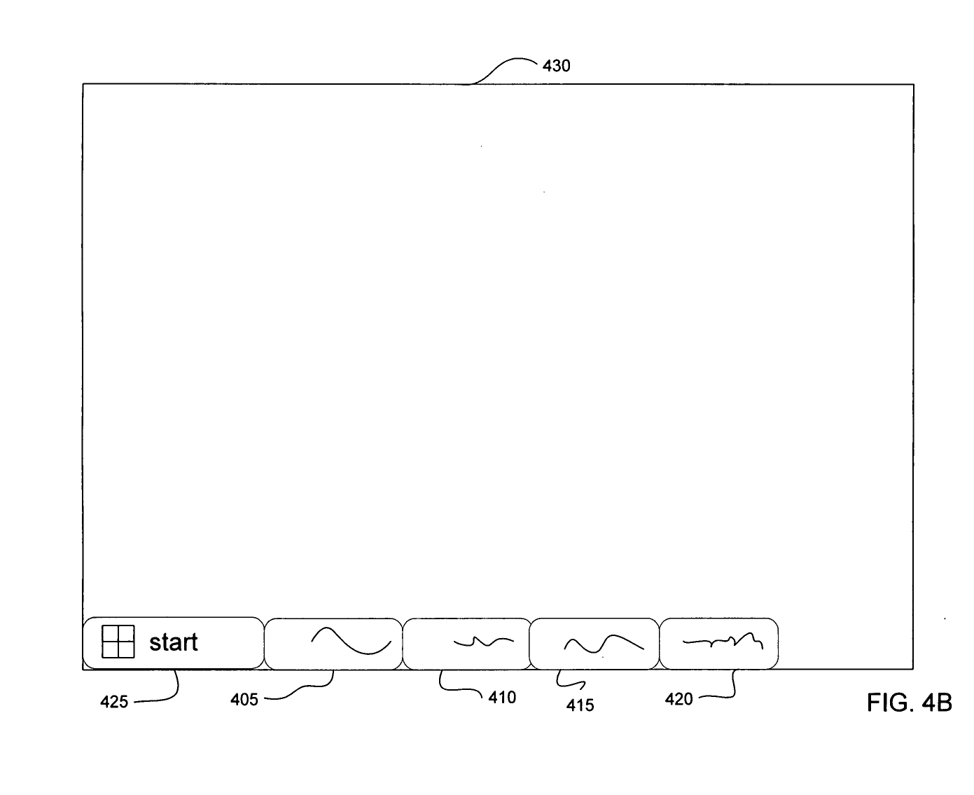

In an embodiment if an open window is minimized when the windows management feature grid is activated, the window view is displayed in a cell in the grid proportionally scaled from it normal, maximized, size to fit within the cell. Thus, for example, assume that an embodiment windows management feature grid is triggered, or activated, when each of the open windows 105, 110, 115 and 120 of FIGS. 1A and 1B are minimized and represented as respective Taskbar buttons 405, 410, 415 and 420 on computing device display 430 of FIG. 4B. In this embodiment and example, views of each of windows 105, 110, 115 and 120 will be displayed in the grid as shown in FIG. 1C, proportionally scaled from the windows' normal, maximized, size as shown in FIGS. 1A and 1B to fit within their respective grid cells.

In an embodiment the windows that are displayed simultaneously unobscured in a grid with the windows management feature are those open windows enabled on the computing device that are identified in the Taskbar and/or via the Alt-Tab feature. Buttons 405, 410, 415 and 420 of FIG. 4B identify exemplary open windows in a Taskbar of a computing device display 430. And as previously discussed, pressing the “Alt” key on a keyboard associated with the computing device simultaneously with pressing the “Tab” keyboard key will, at least with some computing device systems, cause a small window to be exhibited on the computing device display which shows the icons of the currently open windows for the computing device.

In an embodiment open windows that can be simultaneously exhibited unobscured with the windows management feature are those windows that are enabled and have the visible property, i.e., are, or would be, visible to a user if not obscured by any other window, and which are not tool windows or inactive windows, i.e., windows that can not be activated. An example of a tool window is the window identified by the “start” button 425 of FIG. 4B. An example of an inactive window is a magnifier window, i.e., a window which can be used to magnify the contents of other windows exhibited on a computing device display.

In an embodiment the windows management feature determines the open windows to display simultaneously unobscured by identifying all top-level windows and then filtering out those identified top-level windows that are not represented in the Taskbar and/or via the Alt-Tab feature. In an embodiment the windows management feature identifies all the top-level windows using the EnumWindows( ) API. In an embodiment the windows management feature identifies the top-level windows that are represented in the Taskbar and/or via the Alt-Tab feature by searching for ‘application’/‘overlap’/‘pop-up’ type top-level windows that are enabled and have the visible property, i.e., are, or would be, visible to a user if not obscured by any other window, and which are not a tool window or an inactive window. In this embodiment, the top-level windows that fail to meet this criteria are filtered out, i.e., not included in the grid display of open windows enabled by the windows management feature.

In an embodiment the windows management feature displays a snapshot, if available, of each open window in a respective cell of the windows management feature grid. If, however, snapshots were captured for all open windows when an embodiment windows management feature grid is triggered, or activated, this could, depending on the number of open windows and the open windows' contents, cause a significant time lag for the grid to be populated and displayed. Nevertheless, recent window snapshots are desirable.

Thus, in an embodiment a shell hook is established and on each HSHELL_WINDOWACTIVATED notification, when a new window is opened by the computing device system, the new window is examined to see if it meets the criteria for being displayed by a windows management feature grid. The new window is reviewed, therefore, to determine if it is an active, enabled window that is other than a tool window and if it has the visible property. If the newly opened window meets the criteria for being displayed in a windows management feature grid, in an embodiment, after a predetermined time delay, a snapshot of the window is taken, or captured, and added to, i.e., stored in, a memory cache, e.g., a windows snapshot cache. In this embodiment the predetermined time delay between a window being opened and its snapshot being captured for the windows management feature grid is to allow time for the window to be properly, and completely, initialized. In an embodiment the predetermined time delay is five (5) seconds. In alternative embodiments other predetermined time delay values are employed.

In the example of FIGS. 1A and 1B a snapshot of window 120 is taken a predetermined time after window 120 is activated, i.e., a predetermined time after a user enables the respective spread-sheet application accessible via window 120. Likewise, snapshots of windows 115 and 110 are taken a predetermined time after each of these windows is activated by a user enabling the respective instances of an internet access application. A snapshot of window 105 is also taken a predetermined time after window 105 is activated, i.e., a predetermined time after a user enables the respective word processing application accessible via window 105.

In an embodiment, when a user triggers, or otherwise activates, a windows management feature grid a snapshot of the foreground window, i.e., the top window in the z-order of the computing device display, is taken. This snapshot is used for displaying the foreground window in its appropriate cell in the grid. In this embodiment a snapshot of the foreground window is taken when the windows management feature grid is triggered, or otherwise activated, enabled or toggled on, as it is likely the most recently used window by the user, and thus likely the window that has been most currently altered from when it was activated and its last snapshot was taken.

In the example of FIG. 1A a snapshot of window 105, the foreground window on computing device display 100, is taken when an embodiment windows management feature grid is triggered by a user.

In an embodiment, when a user triggers a windows management feature grid, other than for the foreground open window, the cached snapshot, if it exists, for each open window is displayed in the grid. In an embodiment, if there are any open windows other than the foreground window for which a snapshot is not cached when a user triggers a windows management feature grid a snapshot of each of these open windows is now taken, if possible, and displayed in the grid.

In an embodiment when a new window is first launched, i.e., activated, the icon and title of the open window is identified and stored. In an embodiment this information, i.e., the icon and title for an open window, is exhibited in the respective cell for the open window in the grid in place of a snapshot of the open window when a snapshot cannot be captured, for whatever reason, and no snapshot of the window is available, i.e., stored, in the windows snapshot cache.

In an embodiment, for the Windows 2000™ operating system, the BitBlt( ) API is used to capture a snapshot of an open window when the open window is in the foreground of the computing device display.

In an embodiment, for Windows XP™ and later Windows™ version operating systems, the PrintWindow( ) API is used to capture snapshots of all open windows that have not been minimized.

The snapshots of the open windows on a computing device display can be arranged, or otherwise ordered, in the cells of a windows management feature grid in various manners in various alternative embodiments.

In an embodiment the windows management feature populates the grid cells with the views of the open windows based on the window order identified with the Alt-Tab feature, i.e., from the most recently used open window to the least recently used open window. In this embodiment the order of use of the open windows can be ascertained using HSHELL_WINDOWACTIVATED notification messages. In an aspect of this embodiment the most recently used open window is displayed in the top left cell position and the least recently used open window is displayed in the bottom right cell position. In this aspect of this embodiment open windows are assigned cells in the grid from the top left to the bottom right.

Referring again to FIG. 1C, in this embodiment, as window 105 was the most recently used window of the example of FIGS. 1A and 1B, window 105 is displayed in the top left cell position of the grid exhibited on the computing device display 150. Window 110 was the next most recently used window, and thus it is displayed in the top right cell position of the grid. Window 115 was the third most recently used window, and thus it is displayed in the bottom left cell position of the grid. Finally window 120 was the least recently used window, and it is therefore displayed in the bottom right cell of the grid.

In an alternative embodiment open windows are assigned respective cells of a windows management feature grid in the same order that the EnumWindows( ) API arranges the open windows, i.e., based on the z-order of the non-minimized, i.e., maximized, open windows on the computing device display. In an aspect of this alternative embodiment the top, i.e., foreground, maximized open window in the z-order of the computing device display is exhibited in the top left cell position and the bottom maximized open window in the z-order is exhibited in the bottom right cell position. In this aspect of this alternative embodiment maximized open windows are assigned cells in the grid from the top left to the bottom right. In this alternative embodiment minimized open windows are assigned random cell positions in the grid.

In yet a second alternative embodiment the windows management feature populates the grid cells with open windows based on the order of the windows as identified in the Taskbar of the computing device display, i.e., as determined by the application launch, or activation, order, of the applications hosted by the various open windows. In an aspect of this second alternative embodiment open windows are ordered in the grid cells from the most recently launched open window to the least recently launched open window. In this second alternative embodiment the order of activation of the applications hosted by the various open windows can be ascertained using HSHELL_WINDOWCREATED notification messages. In an aspect of this second alternative embodiment the most recently activated open window is displayed in the top left cell position and the least recently activated open window is displayed in the bottom right cell position. In this aspect of this second alternative embodiment open windows are assigned cells, based on their Taskbar order, from the top left to the bottom right of the grid.

In an embodiment if a windows management feature grid is activated, displaying all current open windows simultaneously, and unobscured, and a new open window is automatically launched, or otherwise activated, the new open window is not exhibited in the current grid. In this embodiment the new open window that is automatically launched is displayed in a grid cell by the windows management feature when a new grid is thereafter activated.

In an alternative embodiment if a windows management feature grid is activated, displaying all the current open windows simultaneously, and unobscured, and a new open window is automatically launched, or otherwise activated, a view of the new open window is displayed in an empty cell of the grid. In this alternative embodiment if there is no currently empty cell for displaying the newly open window, the grid is redrawn to include at least a cell for accommodating a view of the new open window.

In yet a second alternative embodiment if a windows management feature grid is activated, displaying all the current open windows simultaneously, and unobscured, and a new open window is automatically launched, or otherwise activated, the grid is reformatted to accommodate displaying a view of the new open window in a cell. In this second alternative embodiment the view of the new open window is displayed in the grid cell used to display the most current open window and all other window views are positioned, or repositioned as necessary, in the various other grid cells.

In an embodiment any notifications that are sent to the computing device display are presented, i.e., exhibited, in their normal manner when a windows management feature grid is activated. Thus, in this embodiment notifications are not affected by the windows management feature.

In an embodiment two or more computing device displays may be linked, or otherwise associated, and used to exhibit various open windows. In an embodiment when a windows management feature grid is enabled, all the open windows from all the linked computing device displays are exhibited in one grid on one computing device display, designated the primary computing device display. Thus, in this embodiment all open windows on all the linked computing device displays are taken into account when the grid cell size is determined.

In an embodiment an open window may cross two or more associated computing device displays, i.e., screens, when normally exhibited. In an embodiment if there is an open window that crosses two or more associated computing device displays when a windows management feature grid is activated, the window is proportionally sized in the same manner as all other open windows to fit within its assigned grid cell.

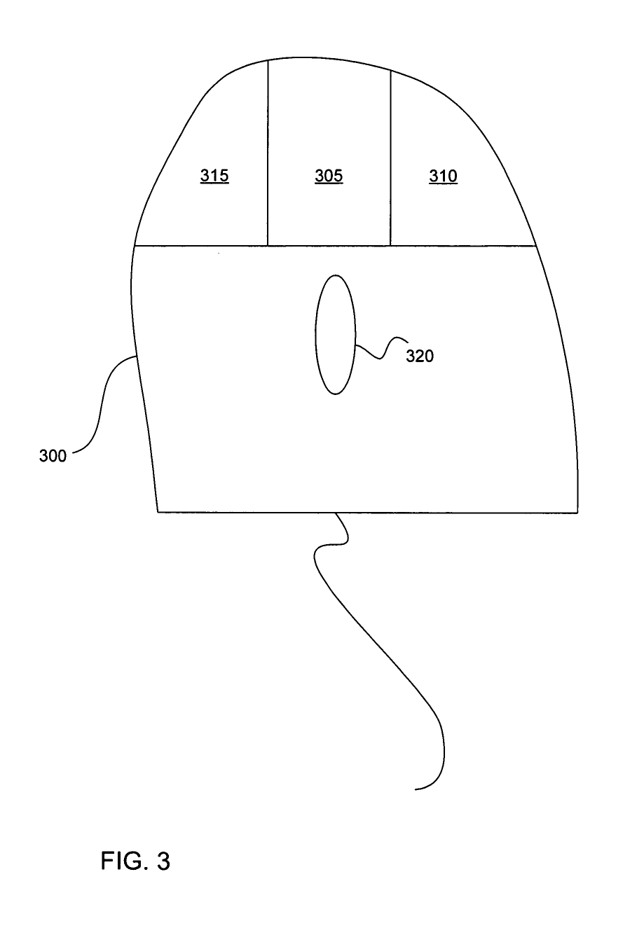

In an embodiment a windows management feature grid is activated by a user pressing a pre-assigned button on the mouse associated with the computing device. Referring to FIG. 3, in an embodiment a windows management feature grid is activated by a user pressing the middle button 305 on a three-button mouse 300 associated with the computing device. In an embodiment one user click on this middle mouse button 305 causes the windows management feature to quickly exhibit the most recent snapshots, if available, of all open, activated windows simultaneously on the computing device display in a grid formation.

In alternative embodiments a windows management feature grid is activated by a user pressing another pre-determined button on a mouse associated with the computing device. For example, in an alternative embodiment a grid is activated by a user pressing the right button 310 on a three-button mouse 300. In yet another alternative embodiment a grid is activated by a user pressing the left button of a two-button mouse.

In an embodiment a key on a keyboard associated with the computing device is also, or alternatively, assigned the windows management feature grid enable functionality. In an embodiment a user typing the assigned key once causes the windows management feature to quickly show the most recent snapshots, if available, of all open, activated windows simultaneously on the computing device display in a grid formation.

In an embodiment, when a user presses the mouse button assigned the windows management feature grid enable functionality when a grid is activated this action turns off, or otherwise toggles off or disables, the windows management feature grid. Thus, in this embodiment a second user click on the assigned mouse button toggles the windows management feature grid off. In an embodiment, when a user toggles the grid off using the assigned mouse button this action causes the windows management feature to transition all open windows displayed in grid cells to their previous x-y positions and sizes and z-orders on the computing device display.

For example, refer to FIG. 1C where a grid is activated and views of all open windows 105, 110, 115 and 120 are currently simultaneously displayed. If a user now once again clicks the assigned mouse button for the windows management feature grid, the grid is toggled off and the open windows 105, 110, 115 and 120 are redisplayed on the computing device display 100 as shown in FIGS. 1A and 1B.

In an embodiment typing the key assigned the windows management feature grid enable functionality when a grid is activated turns off, or otherwise toggles off or disables, the grid. In an embodiment, when a user types the keyboard key assigned the windows management feature grid enable functionality to toggle the grid off, this action causes the windows management feature to transition all open windows displayed in grid cells to their previous x-y positions and sizes and z-orders on the computing device display.

In an embodiment if a user presses, or types, the ESC key on the keyboard associated with the computing device when a grid is enabled the grid is toggled off. In an embodiment this ESC key action while a grid is enabled also causes the windows management feature to transition all open windows displayed in grid cells to their previous x-y positions and sizes and z-orders on the computing device display.

In an embodiment if a user simultaneously presses, or types, the ALT key and F4 key on the keyboard associated with the computing device when a grid is enabled the grid is toggled off. In an embodiment this ALT key/F4 key action while a grid is enabled also causes all open windows displayed in grid cells to transition to their previous x-y positions and sizes and z-orders on the computing device display.

In an embodiment if a windows management feature grid is enabled and a user presses the left mouse button 315 of the three-button mouse 300 of FIG. 3 associated with the computing device while the mouse 300 is positioned in a grid cell hosting a window view, the grid is toggled off. In an embodiment this action also causes the window associated with the cell that the mouse 300 is positioned on when the user presses the left mouse button 315 to be moved to the foreground on the computing device display and restored to its normal size it its original x-y position. In this embodiment this action causes all other open windows displayed in the grid to transition to their respective x-y positions and sizes and z-orders on the computing device display.

For example, if a user presses the left mouse button 315 while the mouse 300 of FIG. 3 is positioned in the grid cell 125 of FIG. 1C assigned to window 115, the grid is toggled off and, referring to FIG. 4A, window 115 is moved to the foreground of computing device display 400, positioned in the original x-y position it had before the grid was enabled, as shown in FIG. 1B, and restored to its normal size. The other open windows 105, 110 and 120 are transitioned to their respective x-y positions and sizes and z-orders on the computing device display 400.

Referring to FIGS. 1A and 1B, when a grid is enabled for the example of open windows 105, 110, 115 and 120, window 105 is in the foreground of computing device display 100. Window 110 is directly behind window 105 in the z-order and is partially obscured by window 105. Window 115 is behind window 110 in the z-order, i.e., it is the third window back in the z-order, and is completely obscured by windows 105 and 110. Finally, window 120 is the last window in the z-order and is partially obscured by windows 105, 110 and 115.

In an embodiment and this example, after a user presses the left mouse button 315 while the mouse 300 is positioned in the grid cell 125 of FIG. 1C for window 115, windows 105, 110 and 120 are transitioned to their respective z-order on the computing device display 400, factoring in that window 115 is now positioned in the foreground. Thus, as shown in FIG. 4A, window 105, which was originally in the foreground before the grid was enabled, is now positioned second in the z-order, behind window 115. Window 105 is repositioned in the same x-y position with the same x-y dimensions it had before the grid was enabled, but now that window 115 is positioned in front of window 105, window 105 is partially obscured by window 115.

Window 110, which was originally second in the z-order behind window 110, as seen in FIGS. 1A and 1B, before the grid was enabled, is now positioned third in the z-order, transitioned again to be directly behind window 105. Window 110 is also repositioned in the same x-y position with the same x-y dimensions it had before the grid was enabled. However, now that window 115 is positioned in the foreground of computing device display 400, window 110 is partially obscured by both windows 105 and 115.

Finally, window 120, which was originally fourth, and last, in the z-order on the computing device display 100 of FIGS. 1A and 1B, before the grid was enabled, is again repositioned in the last, fourth, z-order on computing device display 400. Now, however, as window 115 has been repositioned to the foreground of computing device display 400, window 120 is directly behind window 110 in the z-order and is partially obscured by windows 105, 110 and 115. Window 120 is repositioned in the same x-y position with the same x-y dimensions it had before the grid was enabled.

In an aspect of this embodiment if the window associated with the grid cell that the mouse 300 is positioned on when a user presses the left mouse button 315 of the three-button mouse 300 was minimized prior to the grid being enabled, as well as the selected window being moved to the foreground on the computing device display when the grid is disabled, the window is restored to the x-y position and size it had prior to being minimized.

In alternative embodiments, if a windows management feature grid is enabled and a user presses another pre-assigned button on a mouse associated with the computing device while the mouse is positioned in a grid cell hosting a window view, the grid is toggled off and the window associated with the cell that the mouse is positioned on is moved to the foreground on the computing device display and restored to its normal size. In these alternative embodiments the user action also causes all the other open windows to transition to their respective x-y positions and sizes and z-orders on the computing device display. In an exemplary alternative embodiment, if a windows management feature grid is enabled and a user presses the right mouse button of a two-button mouse while the mouse is positioned in grid cell 125 of FIG. 1C, the computing device display 400 of FIG. 4A results.

In an embodiment if a windows management feature grid is enabled and a user presses the left mouse button 315 of the three-button mouse 300 of FIG. 3 associated with the computing device while the mouse 300 is positioned outside of any grid cell, the grid is toggled off and all open windows are minimized to respective buttons in the Taskbar, leaving the desktop showing.

For example, in this embodiment if a user presses the left mouse button 315 of the three-button mouse 300 while the mouse 300 is positioned at X 130 on the computing device display 150 of FIG. 1C, the mouse 300 is positioned outside of any grid cell. This action causes the grid to toggle off and, referring to FIG. 4B, the open windows 105, 110, 115 and 120 are minimized to respective buttons 405, 410, 415 and 420 in the Taskbar, leaving the desktop showing on the computing device display 430.

Any open, minimized window 105, 110, 115 and/or 120 can thereafter be maximized to its original, normal, x-y position and size by a user, e.g., positioning the mouse associated with the computing device on the respective Taskbar button and clicking a mouse button once. Thus, for example, a user can position the computing device mouse on Taskbar button 405 and click a mouse button once to maximize window 105 to its original x-y position and size on the computing device display.

In alternative embodiments, if a windows management feature grid is enabled and a user presses another pre-assigned button on a mouse associated with the computing device when the mouse is positioned outside of any grid cell, the grid is toggled off and all open windows are minimized to respective Taskbar buttons, leaving the desktop showing. For example, in an alternative embodiment if a grid is enabled and a user presses the right button on a two-button computing device mouse when the mouse is positioned outside any grid cell, e.g., at X 130 on computing device display 150 of FIG. 1C, the grid is toggled off and all open windows are minimized as respective Taskbar buttons, leaving the desktop showing.

In an embodiment positioning, or otherwise hovering, the computing device mouse over a grid cell displaying an open window view while a grid is activated causes the respective window view to be specified. In an embodiment positioning, or otherwise hovering, a computing device pen over a grid cell displaying an open window view while a grid is activated causes the respective window view to be specified. In an embodiment a specified window view is highlighted.

In an embodiment positioning, or otherwise hovering, the computing device mouse over a Taskbar button representing an open window while a grid is activated causes the respective window view to be specified. Thus, for example, in this embodiment if a user positions the computing device mouse over Taskbar button 405 wherein a grid is activated, the view of window 105 of FIG. 1C is specified.

In an embodiment positioning, or otherwise hovering, a computing device pen over a Taskbar button representing an open window while a grid is activated causes the respective window view to be specified. Thus, for example, in this embodiment if a user positions the computing device pen over Taskbar button 405 wherein a grid is activated, the view of window 105 of FIG. 1C is specified.

In an embodiment a user can utilize the scroll wheel on the computing device mouse, e.g., scroll wheel 320 on mouse 300, to specify window views displayed in a grid.

In an embodiment moving the mouse scroll wheel in a first direction causes the window view specification in the grid to transition from the currently specified window view in the direction of top left cell to bottom right cell, on a grid row by grid row basis. As an example of this embodiment, and referring to FIG. 1C, if the view of window 105 is currently specified and a user moves the mouse scroll wheel in a first direction this action causes the window view specification to transition from the window 105 view to the window 110 view, and if the user continues to scroll in this first direction, to the window 115 view, and lastly, to the window 120 view.

In an embodiment moving the mouse scroll wheel in a second direction, i.e., the direction opposite the first direction, causes the window view specification in the grid to transition from the currently specified window view in the direction of bottom right cell to top left cell, on a grid row by grid row basis. As an example of this embodiment, and again referring to FIG. 1C, if the view of window 115 is currently specified and a user moves the mouse scroll wheel in a second direction this action causes the window view specification to transition from the window 115 view to the window 110 view, and if the user continues to scroll in this second direction, to the window 105 view.

In an embodiment a user can type, or press, the arrow keys to cause the window view specification to transition from the currently specified window view in the direction of the arrow key. As an example of this embodiment, and referring to FIG. 1C, if the view of window 110 is currently specified and a user presses the down arrow key, this action causes the window view specification to transition from the window 110 view to the window 120 view. In a second example of this embodiment, if the view of window 110 of FIG. 1C is currently specified and a user presses the left arrow key, this action causes the window view specification to transition from the window 110 view to the window 105 view.

In an embodiment if a user types, or presses, an arrow key that would cause the window view specification to transition off the grid, there is no response to this action. For example, and again referring to FIG. 1C, if the view of window 110 is currently specified and a user presses the up arrow key, or the right arrow key, either of these actions result in no response, and the window 110 view remains specified.

In an embodiment, if the arrow key functionality is enabled for the num pad on the keyboard associated with the computing device, a user can type, or press, the respective keys associated with arrow key functionality on the num pad to cause the window view specification to transition from the currently specified window view in the direction of the arrow of the respective num pad key.

In an embodiment if a user types, or presses, a num pad key associated with an arrow key functionality that would cause the window view specification to transition off the grid, there is no response to this action.

In an embodiment if a user types, or presses, the “enter” key on the keyboard associated with the computing device while a windows management feature grid is activated and a window view exhibited in a cell grid is specified this action causes the window whose view is specified to be selected and disables the grid. In an embodiment this user action causes the selected window to be positioned in the foreground on the computing device display and restored to its normal size in its original x-y position. In this embodiment this action causes all other open windows displayed in the grid to transition to their respective x-y positions and sizes and z-orders on the computing device display.

As an example of this embodiment, if a user types the “enter” key on the keyboard associated with the computing device while a windows management feature grid is activated and the view of window 115 of FIG. 1C is specified, window 115 is selected and the grid is toggled off. This user action causes window 115 to be positioned in the foreground on the computing device display and restored to its normal size in its original x-y position, as shown in FIG. 4A. This user action causes all the other open windows, 105, 110 and 120, to transition to their respective x-y positions and sizes and z-orders, as exhibited on the exemplary computing device display 400 of FIG. 4A.

In this example, as window 115 is positioned in the foreground when the user types the “enter” key, window 105 is positioned second in the z-order of the computing device display 400, behind window 115. Window 110 is now positioned third in the z-order of the computing device display 400, behind window 105 and also behind window 115. Finally, window 120 remains positioned fourth, and last, in the z-order of the computing device display 400, but it is now positioned directly behind window 110.

In an embodiment if a user types, or presses, the spacebar on the keyboard associated with the computing device while a windows management feature grid is activated and a window view exhibited in a cell grid is specified this action causes the window whose view is specified to be selected and disables the grid. In an embodiment this user action causes the selected window to be positioned in the foreground on the computing device display and restored to its normal size in its original x-y position. In this embodiment this user action causes all other open windows displayed in the grid to transition to their respective x-y positions and sizes and z-orders on the computing device display.

In an embodiment if a grid is enabled and a user clicks the computing device pen while the computing device pen is positioned on a grid cell displaying a window view, or a window view in a grid cell is otherwise specified, the window whose view is specified is selected and the grid is toggled off. In an embodiment this user action causes the selected window to be positioned in the foreground on the computing device display and restored to its normal size it its original x-y position. In this embodiment this user action causes all the other open windows displayed in the grid to transition to their respective x-y positions and sizes and z-orders on the computing device display.

In an embodiment if a user types, or presses, any key on the keyboard associated with the computing device other than the “enter” key, the spacebar, the arrow keys, the num pad keys associated with arrow key functionality, or the key pre-assigned the windows management feature grid enable functionality when a grid is activated this action toggles the windows management feature grid off. In this embodiment this user action causes all the open windows displayed in the grid to transition to their normal sizes, x-y positions and z-order on the computing device display.

For example, assume a user types, or presses, the “A” key on the keyboard associated with the computing device when a grid is activated and views of the open windows 105, 110, 115 and 120 are exhibited in grid cells as shown in FIG. 1C. In this embodiment this user action causes the grid to toggle off and all the open windows 105, 110, 115 and 120 to transition to their normal sizes, x-y positions and z-order as shown on computing device display 100 of FIGS. 1A and 1B.

In an alternative embodiment if a user types, or presses, various keys unassigned any windows management feature functionality on the keyboard associated with the computing device when a grid is activated the grid is disabled. In this embodiment the user action causes all the open windows displayed in the grid to transition to their normal sizes, x-y positions and z-order on the computing device display.

For example, in one alternative embodiment if a user types the “C” key on the keyboard associated with the computing device when a grid is activated and views of the open windows 105, 110, 115 and 120 are exhibited in grid cells as shown in FIG. 1C, the grid is disabled and all the open windows are transitioned to their normal sizes, x-y positions and z-order as shown on the computing device display 100 of FIGS. 1A and 1B. As another example, however, in this same alternative embodiment if a user types the “esc” key on the keyboard associated with the computing device when a grid is activated and views of the open windows 105, 110, 115 and 120 are exhibited in grid cells as shown in FIG. 1C, no action results and the computing device display 100 of FIG. 1C remains as shown.

In an embodiment if a user closes, or otherwise dismisses, a Taskbar button associated with an open window while a grid is activated, the respective open window is closed and its view is removed from display in the grid. The grid is updated, i.e., re-exhibited or redrawn, to show only the views of the currently open windows.

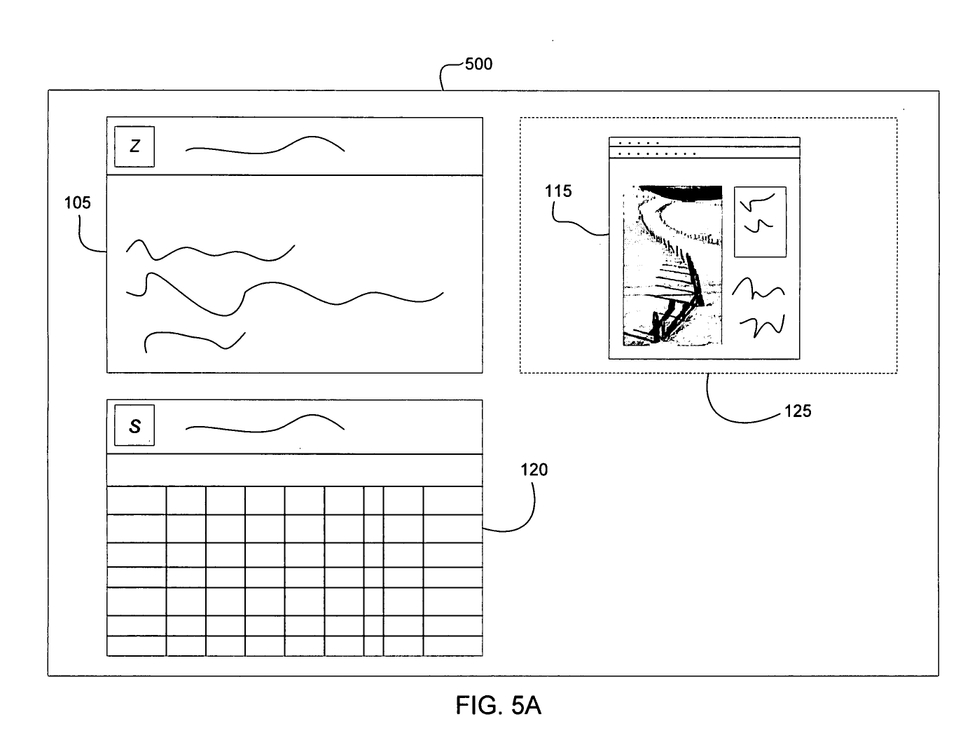

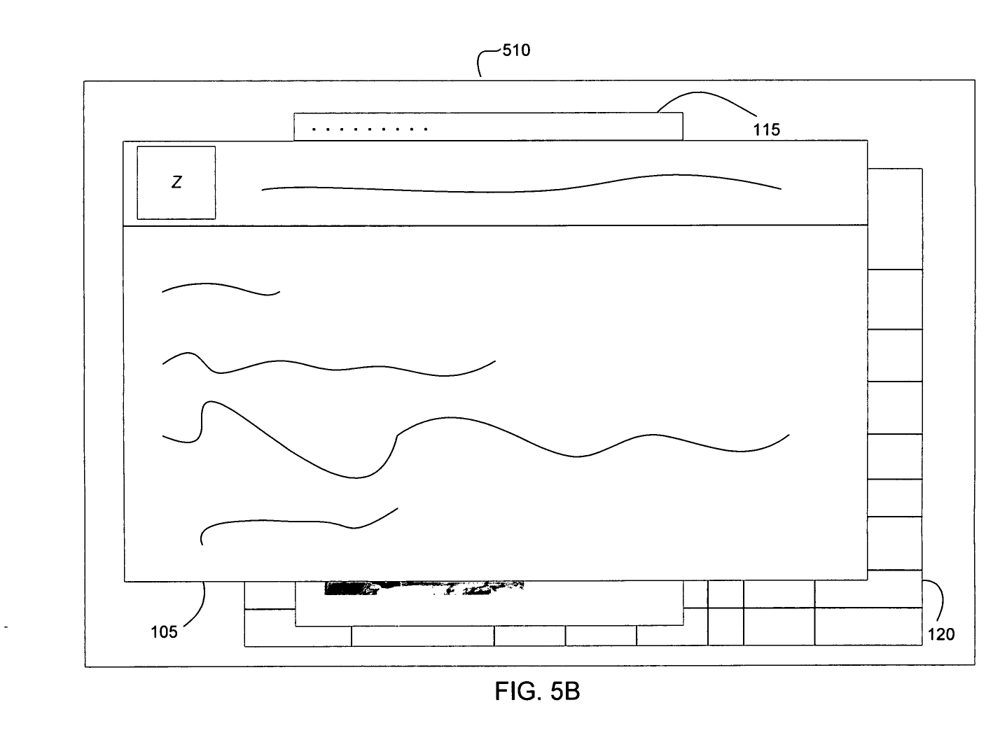

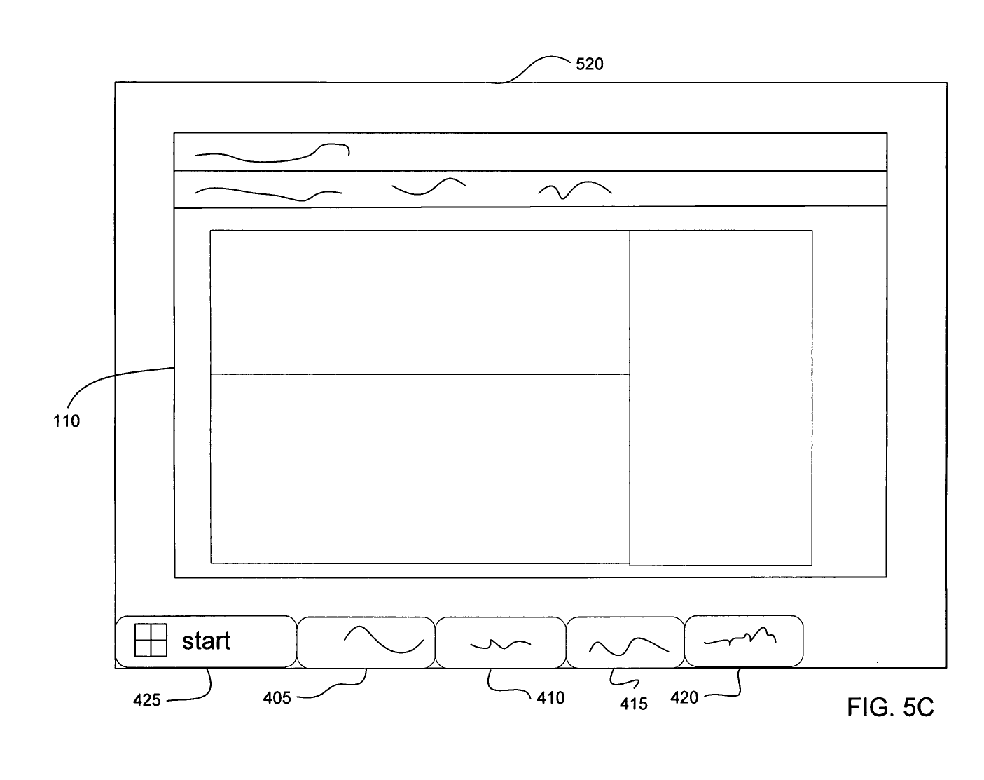

For example, in this embodiment if a user closes Taskbar button 410 when a grid is activated and views of the open windows 105, 110, 115 and 120 are displayed in the grid as shown on the exemplary computing device display 150 of FIG. 1C, window 110 associated with Taskbar button 410 is closed and its view is removed from the grid. The grid is redrawn to show views of only the currently open windows, 105, 115 and 120, as exhibited in the exemplary computing device display 500 of FIG. 5A. As can be seen in FIG. 5A, the view of window 110 is no longer displayed in a grid cell. And because window 110 is no longer represented in the grid, the views of windows 115 and 120 are repositioned in the grid to reflect their respective windows' new positional order.

In this embodiment and example if the grid is then toggled off, open windows 105, 115 and 120 are transitioned to their normal sizes, x-y positions and relative z-order as shown in the exemplary computing device display 510 of FIG. 5B. Window 110 is no longer an open window, and thus does not appear in the computing device display 510. And because window 110 has been closed, window 115 is now partially visible behind window 105.

In this example for this embodiment, window 105 is positioned in its normal first-place z-order on the computing device display 510 when the grid is toggled off. Window 115 is repositioned directly behind window 105, in the second z-order on the computing device display 510. Closing window 110 has allowed window 115 to be repositioned from its original third-place z-order to its new second-place z-order on the computing device display 510. Window 120 remains positioned directly behind window 115 in the last z-order on the computing device display 510.

In an embodiment if an open window is automatically closed by the computing device system while a grid is enabled or when a grid is toggled on, e.g., the window of a scheduled automatic task is closed by the computing device system while a grid is enabled or when a grid is toggled on, the respective open window is closed and its view is removed from display in the grid. The grid is updated, i.e., re-exhibited or redrawn, to show only the views of the currently open windows.

In an embodiment if a user selects a Taskbar button representing an open window while a grid is activated the grid is toggled off. In an embodiment this user action causes the open window associated with the selected Taskbar button to be positioned in the foreground on the computing device display and restored to its normal size in its original x-y position. In this embodiment this user action causes all other open windows displayed in the grid to transition to their respective x-y positions and sizes and z-orders on the computing device display.

For example, in this embodiment if a user selects the Taskbar button 415 while a grid is activated and exhibits views of open windows 105, 110, 115 and 120 as shown on the computing device display 150 of FIG. 1C, the grid is toggled off. Referring to FIG. 4A, this user action results in window 115, associated with Taskbar button 415, being positioned in the foreground of computing device display 400, restored to its normal size and repositioned in the original x-y location it had before the grid was enabled, as shown in FIG. 1B. This user action in this embodiment results in the other open windows 105, 110 and 120 transitioning to their respective x-y positions and sizes and z-orders on the computing device display 400.

In this embodiment and example, after a user selects the Taskbar button 415 while the grid is enabled, windows 105, 110 and 120 are transitioned to their respective z-order on the computing device display 400 of FIG. 4A, factoring in that window 115 is now positioned in the foreground of computing device display 400. Thus, window 105, which was originally in the foreground before the grid was enabled, as shown in FIG. 1A, is now located second in the z-order, behind window 115 on the computing device display 400 of FIG. 4A. Window 105 is repositioned in the same x-y location with the same x-y dimensions it had before the grid was enabled, but now that window 115 is positioned in front of window 105, window 105 is partially obscured by window 115.

Window 110, which was originally second in the z-order behind window 105 before the grid was enabled, as seen in FIGS. 1A and 1B, is now positioned third in the z-order, transitioned again to be directly behind window 105. Window 110 is repositioned in the same x-y location with the same x-y dimensions it had before the grid was enabled. However, now that window 115 is positioned in the foreground of computing device display 400, window 110 is partially obscured by both windows 105 and 115.

Finally, window 120, which was originally fourth, and last, in the z-order on the computing device display 100 of FIGS. 1A and 1B before the grid was enabled, is again positioned in the last, fourth, z-order on computing device display 400 of FIG. 4A. Now, however, as window 115 has been repositioned to the foreground, window 120 is directly behind window 110 in the z-order. Window 120 is repositioned in the same x-y location with the same x-y dimensions it had before the grid was enabled. As window 115 is now in the foreground, window 120 is partially obscured by windows 105, 110 and 115.

In an alternate embodiment if a user selects a Taskbar button representing an open window while a grid is activated the windows grid is toggled off and the open window associated with the selected Taskbar button is restored to its normal size it its original x-y position on the computing device display. In this alternate embodiment this user action causes all other open windows displayed in the grid to be minimized, i.e., represented by respective Taskbar buttons.

For example, in this alternative embodiment if a user selects the Taskbar button 410 while a grid is activated and exhibits views of open windows 105, 110, 115 and 120 as shown in FIG. 1C, the grid is toggled off. In this alternative embodiment and example, and referring to FIG. 5C, this user action results in window 110, associated with Taskbar button 410, being restored to its normal size and repositioned in the original x-y location on the exemplary computing device display 520 that it had before the grid was enabled, as shown in FIG. 1B. In this alternative embodiment and example, this user action results in the other open windows 105, 115 and 120 being minimized and represented by respective Taskbar buttons 405, 415 and 420 on the computing device display 520 of FIG. 5C.

In an embodiment associated windows may be grouped and represented by one Taskbar button if, for example, there is not enough room on the Taskbar to represent each such associated window with an individual Taskbar button. In an aspect of this embodiment associated windows are windows that represent different program activation instances. For example, windows 110 and 115 of FIGS. 1A and 1B may be grouped and represented by one Taskbar button, also referred to herein as a grouped windows Taskbar button, as they represent different instances of the same internet access application.

In an embodiment if a user selects a grouped windows Taskbar button the grouped windows Taskbar button is expanded to include individual Taskbar buttons for each window represented by the grouped windows Taskbar button. In this embodiment if a windows management feature grid is activated when a user selects a grouped windows Taskbar button to expand the user action has no affect on the display of the grid.

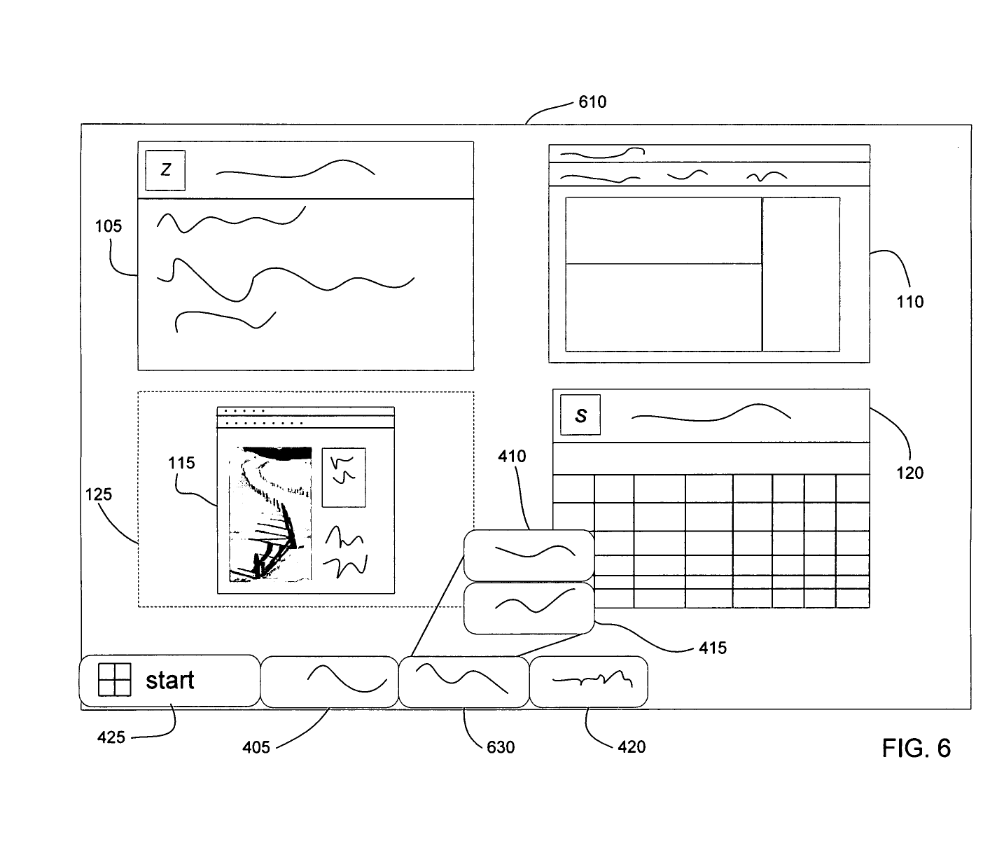

For example, and referring to FIG. 6, assume that open windows 110 and 115 are represented by a grouped Taskbar button 630 on the exemplary computing device display 610. Open window 105 is represented by Taskbar button 405 and open window 120 is represented by Taskbar button 420. In an embodiment if a user selects the grouped Taskbar button 630, the grouped Taskbar button 630 is expanded to show individual Taskbar buttons 410 and 415 for each represented window 110 and 115. If a grid is activated when the grouped windows Taskbar button 630 is expanded there is no affect on the display of the grid, i.e., the exemplary computing device display 610 of FIG. 6 is unaffected by the user action.

In an embodiment if a user positions, or otherwise hovers, the computing device mouse or pen over a grouped windows Taskbar button that is not expanded while a grid is enabled the grouped windows Taskbar button remains unexpanded and there is no affect on the display of the grid. Thus, for example, in this embodiment if a user positions the computing device mouse over grouped windows Taskbar button 630 of FIG. 6, the grouped Taskbar button 630 is not expanded and the display of the grid is unaffected.

In an embodiment if a grid is enabled and a user selects an open window from a grouped windows Taskbar button the grid is toggled off.

In an embodiment a user can view Taskbar buttons for the individual open windows represented by a grouped windows Taskbar button by pressing the left button on the mouse associated with the computing device while the mouse is positioned over the grouped windows Taskbar button. In an embodiment a user can then select a window represented by a grouped windows Taskbar button by pressing the left mouse button a second time while the mouse is positioned over the respective individual Taskbar button for the window.

In an embodiment the user action of selecting an open window from a grouped windows Taskbar button causes the selected open window to be positioned in the foreground on the computing device display and restored to its normal size it its original x-y position. In this embodiment the user action causes all other open windows displayed in the grid to transition to their respective x-y positions and sizes and z-orders on the computing device display.

For example, in this embodiment, and referring to FIG. 6, when a user presses the left button on their computing device mouse a first time while the mouse is positioned over grouped windows Taskbar button 630, Taskbar button 410 and Taskbar button 415 are exhibited for the open windows 110 and 115 that are represented by the grouped windows Taskbar button 630. In this example and embodiment f a user then presses the left mouse button a second time while the mouse is positioned over Taskbar button 415, window 115 is selected.

In this embodiment and example, the user action of selecting window 115 from the grouped windows Taskbar button 630 causes the grid to toggle off. Window 115 is positioned in the foreground on the computing device display, e.g., display 400 of FIG. 4A, and restored to its normal size it its original x-y position. This user action further causes all other open windows displayed in the grid, i.e., windows 105, 110 and 120, to transition to their respective x-y positions and sizes and z-orders on the computing device display, e.g., display 400 of FIG. 4A.

In alternative embodiments a user can view Taskbar buttons for the individual open windows represented by a grouped windows Taskbar button by pressing other buttons on the mouse associated with the computing device while the mouse is positioned over the grouped windows Taskbar button, e.g., by pressing the right mouse button or by pressing a middle mouse button of a three-button mouse. In these alternative embodiments a user can select an individual window represented by a grouped windows Taskbar button by pressing the same mouse button a second time while the mouse is positioned over the respective Taskbar button for the individual window.

In yet other alternative embodiments a user can view Taskbar buttons for the individual open windows represented by a grouped windows Taskbar button by clicking a pen associated with the computing device while the pen is positioned over the grouped windows Taskbar button. In these other alternative embodiments a user can select an individual window represented by a grouped windows Taskbar button by clicking the computing device pen a second time while the pen is positioned over the respective Taskbar button for the individual window.

In an alternate embodiment if a user selects a Taskbar button representing an open window while a grid is activated the grid is toggled off and the open window associated with the selected Taskbar button is restored to its normal size it its original x-y position on the computing device display. In this alternate embodiment the user action causes all other open windows displayed in the grid to be minimized, i.e., represented by respective Taskbar buttons.

In an alternate embodiment if a windows management feature grid is enabled and a user selects an open window from a grouped windows Taskbar button the grid is toggled off and the selected open window is moved to the foreground on the computing device display and restored to its normal size it its original x-y position. In this alternate embodiment the user action causes all other open windows displayed in the grid to be minimized, i.e., represented by respective Taskbar buttons. In an aspect of this alternative embodiment, if the selected window is one of only two windows represented by the grouped windows Taskbar button, the grouped windows Taskbar button is replaced with a Taskbar button for the unselected window.

For example, in this alternative embodiment if a user selects window 110 from the grouped windows Taskbar button 630 while the grid is activated and exhibits views of open windows 105, 110, 115 and 120 as shown on the exemplary computing device display 610 of FIG. 6, the grid is toggled off. In this alternative embodiment and example, and referring to FIG. 5C, the user action results in window 110 being restored to its normal size and repositioned in the original x-y location on the exemplary computing device display 520 that it had before the grid was enabled, as shown in FIG. 1B. In this alternative embodiment and example, the user action results in the other open windows 105, 115 and 120 being minimized and represented by respective Taskbar buttons 405, 415 and 420 on the exemplary computing device display 520 of FIG. 5C. In this alternative embodiment and example, as the grouped windows Taskbar button 630 represented only two open windows, 110 and 115, one of which was the user selected window, 110, the grouped windows Taskbar button 630 is replaced with the Taskbar button 415 for the unselected window 115.

In an embodiment if a windows management feature grid is enabled and a user selects any Taskbar element other than the “start” button, e.g., “start” button 425 of FIG. 6, or any Taskbar button for an individual open window or grouped windows Taskbar button representing two or more open windows, e.g., Taskbar buttons 405, 630 and 420 of FIG. 6, such as, but not limited to, any Quick launch icons, Desktop bands or System Tray items, the grid is toggled off. In this embodiment this user action causes all the open windows displayed in the grid to transition to the x-y positions, sizes and z-orders they had on the computing device display prior to the grid being enabled.

For example, assume a user selects a Quick launch icon while a grid is enabled and views of open windows 105, 110, 115 and 120 are exhibited in a grid as shown on exemplary computing device display 610 of FIG. 6. This user action toggles the grid off and transitions the open windows 105, 110, 115 and 120 to the x-y positions, sizes and z-orders they had on the computing device display 100 prior to the grid being enabled, as shown in FIGS. 1A and 1B.

In an embodiment if a windows management feature grid is enabled and a user clicks on the “start” button, i.e., “start” button 425 of FIG. 6, to open the start menu, this action does not disable the grid. In this embodiment the user action causes the start menu to be displayed in the foreground of the computing device display with the grid to be positioned behind the start menu on the computing device display.

In an embodiment if a grid is enabled and a user selects an application or other start feature from the open start menu, the grid is toggled off. In this embodiment the user action causes the newly selected application or other start feature to be launched or otherwise activated. In this embodiment the user action causes all the open windows displayed in the grid to transition to their respective x-y positions, sizes and z-orders on the computing device display. Thus, in this embodiment the newly activated application or other start feature is positioned in the foreground of the computing device display and the open windows whose views were displayed in the grid are positioned behind the newly activated application or other start feature in the relative z-order they held prior to the grid being enabled.

In an alternative embodiment windows management feature if an open window to be displayed in a grid cell is a window that has streaming video, i.e., it is a window that is updated automatically, without any user intervention, the actual window, i.e., the “live” window, rather than a snapshot of the window, is displayed in the appropriate grid cell when a grid is activated by a user. For example, in this alternative embodiment if window 115 of FIGS. 1A and 1B hosts streaming video, the view of window 115 displayed in grid cell 125 of FIG. 1C is the actual window 115, rather than a snapshot of window 115.

In an embodiment windows management feature two or more windows can be activated from a grid in order that a user can compare, cut and paste, and otherwise work within the two or more open windows simultaneously, i.e., in order that a compare scenario involving the two or more selected windows is activated. In this embodiment windows management feature the two or more activated windows are presented simultaneously and unobstructed on the computing device display. In this embodiment each activated window is the actual window for the respective application, i.e., it is a “live” window from which a user can interact with the hosted application.

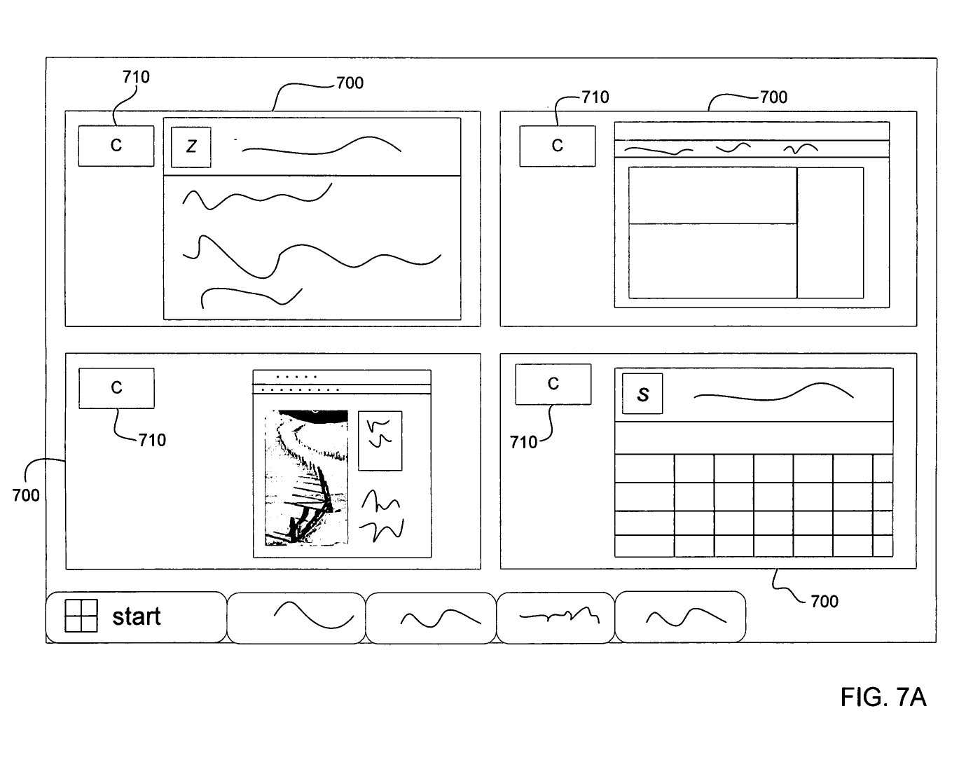

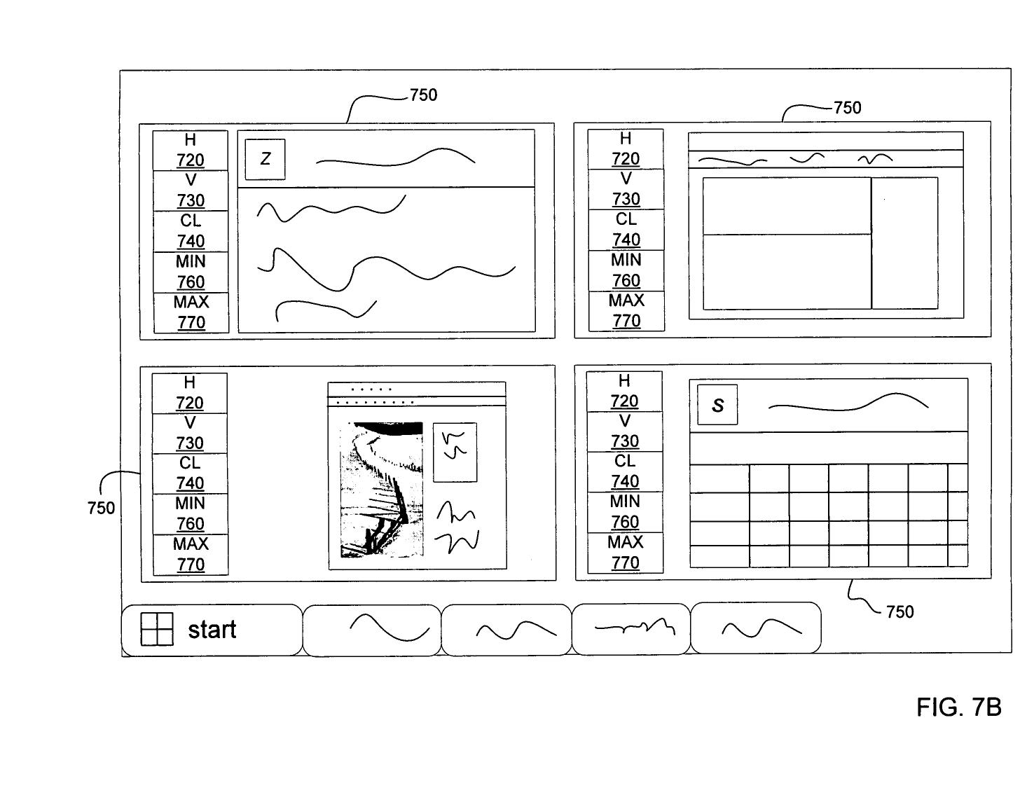

In an embodiment, as shown in FIG. 7A, each cell 700 of a windows management feature grid has a compare button 710 that a user can click on via, e.g., their computing device mouse or computing device pen, to select the respective window for activation in a compare scenario.

In an embodiment a user initiates a compare scenario by clicking on, or otherwise selecting, the compare button 710 in the cell 700 for a first window. In an embodiment a user can continue to click on compare buttons 710 in other cells 700 to select other open windows for the compare scenario. In an embodiment, when all the open windows desired for a compare are selected, the user presses a pre-determined button on their computing device mouse, e.g., the middle mouse button 305 on the three-button mouse 300 of FIG. 3, to activate the selected windows in a compare scenario.

In an alternative embodiment, when all the open windows desired for a compare are selected, the user presses, or otherwise types, a pre-determined key on the computing device keyboard to activate the selected windows in the compare scenario. In yet other alternative embodiments other actions can result in the selected windows being activated in a compare scenario, e.g., a user pressing any mouse button when the mouse is positioned outside any grid cell 700 after two or more windows are selected via respective compare buttons 710, a user clicking the computing device pen when the pen is positioned outside any grid cell 700 after two or more windows are selected via respective compare buttons 710, etc.

In an embodiment a user can deselect a selected window for the compare scenario by clicking on the compare button 710 for the selected window a second time.

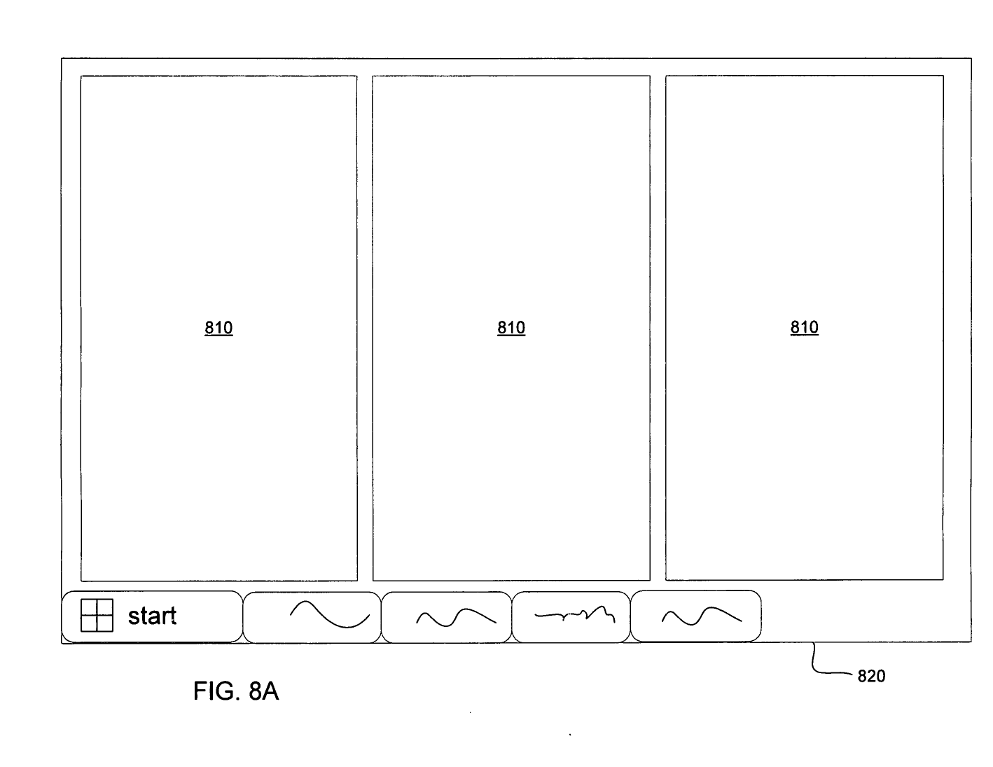

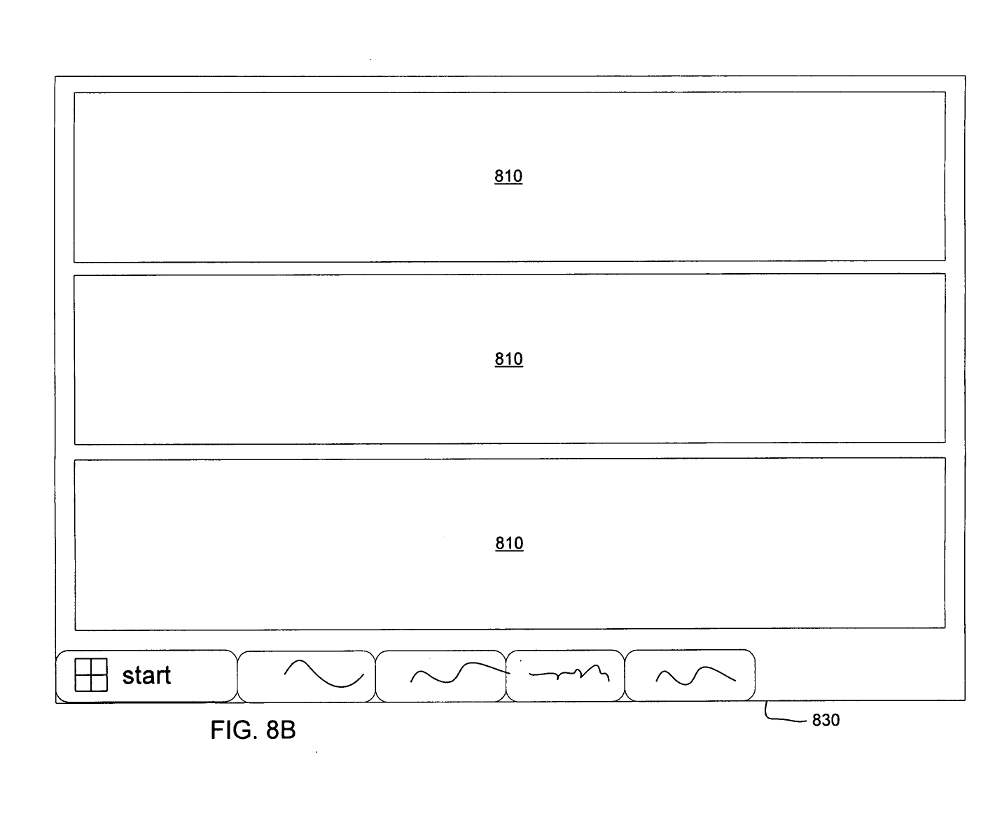

In an embodiment, when a compare scenario is activated the selected windows 810 are displayed simultaneously, and unobstructed, side by side, i.e., horizontally, as shown on the exemplary computing device display 820 of FIG. 8A. In an alternate embodiment, when a compare scenario is activated the selected windows 810 are displayed simultaneously, and unobstructed, one on top of the other, i.e., vertically, as shown on the exemplary computing device display 830 of FIG. 8B. In a second alternative embodiment, when a compare scenario is activated the selected windows are displayed simultaneously, and unobstructed, in cells in a grid. In a third alternative embodiment, when a compare scenario is activated for two selected windows, the selected windows are displayed simultaneously, and unobstructed, horizontally, and when a compare scenario is activated for three or more selected windows, the selected windows are displayed simultaneously, and unobstructed, in cells in a grid. In still other alternative embodiments, selected windows are displayed in other formations on the computing device display.

In an embodiment, when a compare scenario is activated the selected windows 810 are sized as large as possible while allowing for all selected windows 810 to be displayed simultaneously, and unobstructed, and taking into consideration the computing device display size and resolution.

In an alternative embodiment, as shown in FIG. 7B, each cell 750 of a windows management feature grid has a horizontal compare button 720 and a vertical compare button 730 that a user can click on via, e.g., their computing device mouse or computing device pen, to select the respective window for activation in a compare scenario.

In this alternative embodiment a user initiates a compare scenario by clicking on, or otherwise selecting, either the horizontal compare button 720 or the vertical compare button 730 in the cell 750 for a first window. In an aspect of this alternative embodiment, if the user clicks on the horizontal compare button 720 for a window in a first cell 750, then all vertical compare buttons 730 in all the grid cells 750 are disabled. In this same aspect of this alternative embodiment, if the user clicks on the vertical compare button 730 for a window in a first cell 750, then all horizontal compare buttons 720 in all the grid cells 750 are disabled.

In this alternative embodiment if the user first clicked on a horizontal compare button 720 in a cell 750 for a first window, the user can continue to click on the horizontal compare buttons 720 in other cells 750 to select other open windows for the compare scenario. Likewise, in this alternative embodiment if the user first clicked on a vertical compare button 730 in a cell 750 for a first window, the user can continue to click on the vertical compare buttons 730 in other cells 750 to select other open windows for the compare scenario.

In one aspect of this alternative embodiment, when all the open windows desired for a compare are selected, the user presses a pre-determined button on their computing device mouse, e.g., the middle mouse button 305 on a three-button mouse 300 of FIG. 3, to activate the compare scenario. In an alternative aspect of this alternative embodiment, when all the open windows desired for a compare are selected, the user presses, or otherwise types, a pre-determined key on the computing device keyboard to activate the compare scenario. In still other alternative aspects of this alternative embodiment other actions can result in the compare scenario being activated, e.g., a user pressing any mouse button when the mouse is positioned outside any grid cell 750 after two or more windows are selected via their cells' respective horizontal compare buttons 720 or vertical compare buttons 730, a user clicking the computing device pen when the pen is positioned outside any grid cell 750 after two or more windows are selected via their cells' respective horizontal compare buttons 720 or vertical compare buttons 730, etc.

In this alternative embodiment, when a compare scenario is activated after the user has selected two or more windows using the horizontal compare buttons 720 in the respective cells 750 for the windows, the selected windows 810 are displayed simultaneously, and unobstructed, side by side, i.e., horizontally, as shown on the exemplary computing device display 820 of FIG. 8A. In this alternate embodiment, when a compare scenario is activated after the user has selected two or more windows using the vertical compare buttons 730 in the respective cells 750 for the windows, the selected windows 810 are displayed simultaneously, and unobstructed, one on top of the other, i.e., vertically, as shown on the exemplary computing device display 830 of FIG. 8B.

In a second alternative embodiment two windows can be activated from a windows management feature grid in order that a user can compare, cut and paste, and otherwise work within the two open windows simultaneously, i.e., in order that a compare scenario involving the two selected windows is activated.

In an aspect of this second alternative embodiment, as shown in FIG. 7B, each cell 750 of a windows management feature grid has a horizontal compare button 720 and a vertical compare button 730 that a user can click on, or otherwise select, via, e.g., their computing device mouse or computing device pen, to select the respective window for activation in a compare scenario.

In an aspect of this second alternative embodiment a user initiates a compare scenario by clicking on, or otherwise selecting, either the horizontal compare button 720 or the vertical compare button 730 in the cell 750 for a first window. In an aspect of this second alternative embodiment, if the user clicks on the horizontal compare button 720 for a first window, then all vertical compare buttons 730 in all the grid cells 750 are disabled. In this same aspect of this second alternative embodiment, if the user clicks on the vertical compare button 730 for a first window, then all horizontal compare buttons 720 in all the grid cells 750 are disabled.

In an aspect of this second alternative embodiment, when a user clicks on, or otherwise selects, the horizontal compare button 720, or the vertical compare button 730, in the cell 750 for a second window, the compare scenario is activated and the two selected windows are displayed simultaneously, and unobstructed. In an aspect of this second alternative embodiment, if the user clicked on the horizontal compare buttons 720 in the cells 750 for the first and second selected windows, the two selected windows 810 are exhibited horizontally in the compare scenario, as shown on the exemplary computing device display 820 of FIG. 8A. In this aspect of this second alternative embodiment, if the user clicked on the vertical compare buttons 730 in the cells 750 for the first and second selected windows, the two selected windows 810 are exhibited vertically, as shown on the exemplary computing device display 830 of FIG. 8B.

In an aspect of this second alternative embodiment, if a user clicks on the horizontal compare button 720 in the cell 750 for a first window, to select the first window for a compare scenario, and thereafter clicks a second time on the same horizontal compare button 720 in the cell 750 for the first window before a compare scenario is activated, no windows in the grid are deemed selected for a compare scenario. In this aspect of this second alternative embodiment, if a user clicks on the vertical compare button 730 in the cell 750 for a first window, to select the first window for a compare scenario, and thereafter clicks a second time on the same vertical compare button 730 in the cell 750 for the first window before the compare scenario is activated, no windows in the grid are deemed selected for a compare scenario.

In an embodiment, windows activated in a compare scenario are displayed horizontally, or vertically, on the computing device display using the TileWindows( ) API.

In an embodiment each cell 750 of a windows management feature grid has a close button 740, as shown in FIG. 7B, that a user can click on, or otherwise select, via, e.g., their computing device mouse or computing device pen, to close the respective window whose view is displayed in the cell 750. In an embodiment when a user clicks on the close button 740 for a grid cell 750 the associated window is closed. In an embodiment when a user clicks on the close button 740 for a grid cell 750 the grid is redrawn to exclude a view of the closed window.

In an aspect of this embodiment, when a window is closed by a user selecting a respective close button 740 in a grid cell the window contents are saved prior to the window being closed.

In an embodiment each cell 750 of a windows management feature grid has a minimize button 760, as shown in FIG. 7B, that a user can click on, or otherwise select, via, e.g., their computing device mouse or computing device pen, to minimize the respective window whose view is displayed in the cell 750. In an embodiment when a user clicks on the minimize button 760 for a grid cell 750 the corresponding window displayed in the cell 750 is minimized when the grid is thereafter disabled, or toggled off.

In an embodiment each cell 750 of the windows management feature grid has a maximize button 770, as shown in FIG. 7B, that a user can click on, or otherwise select, via, e.g., their computing device mouse or computing device pen, to maximize the respective window whose view is displayed in the cell 750. In an embodiment when a user clicks on the maximize button 770 for a grid cell 750 the corresponding window displayed in the cell 750 is maximized when the grid is thereafter disabled, or toggled off.

In an alternative embodiment when a user clicks on the maximize button 770 for a grid cell 750 the grid is toggled off, the window associated with the respective cell 750 is maximized on the computing device display and all other open windows exhibited in the grid are minimized, i.e., represented as Taskbar buttons.

In alternative embodiments each cell 750 of a windows management feature grid has one or more other buttons that a user can click on, or otherwise select, via, e.g., their computing device mouse or computing device pen, to cause a specific action to occur. For example, in one alternative embodiment each cell 750 of a windows management feature grid has a live button that, when clicked, or otherwise selected, switches the display in the respective grid cell 750 from a window snapshot to a live representation of the window.

In an alternative embodiment, rather than various buttons for specific actions being hosted by the cells of a windows management feature grid, there is one button in each cell that when clicked, or otherwise selected, causes a pull-down menu of actions, e.g., compare, close, minimize, maximize, and/or etc., to be displayed, which a user can then select from, via, e.g., their computing device mouse or pen.

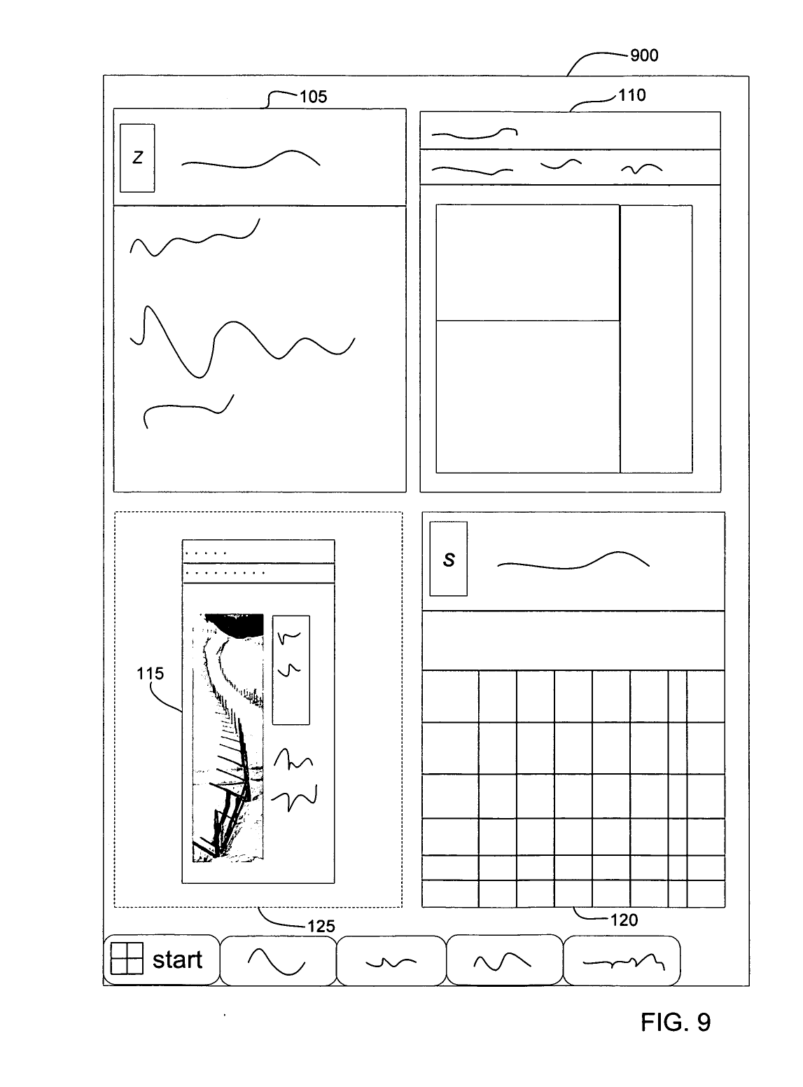

In an embodiment computing device system that has a tablet PC computing device display, or monitor, or a computing device system with a display that has the same capabilities as those of a table PC monitor, when the computing device display's orientation is altered the windows management feature grid is automatically redrawn to reflect the new computing device display orientation. For example, FIG. 1C displays a computing device system tablet PC monitor, i.e., display, 150 in a first orientation with a windows management grid exhibited thereon. If the computing device system table PC monitor 150 is thereafter reoriented ninety degrees, the grid is also automatically reoriented ninety degrees, as shown on the exemplary computing device system tablet PC monitor 900 of FIG. 9.

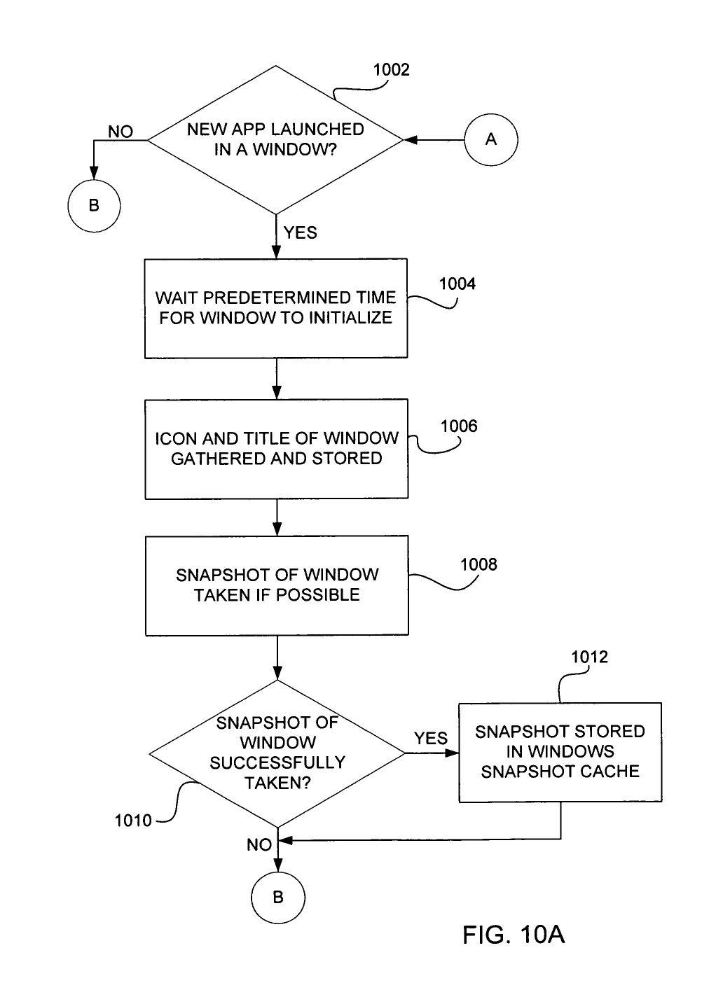

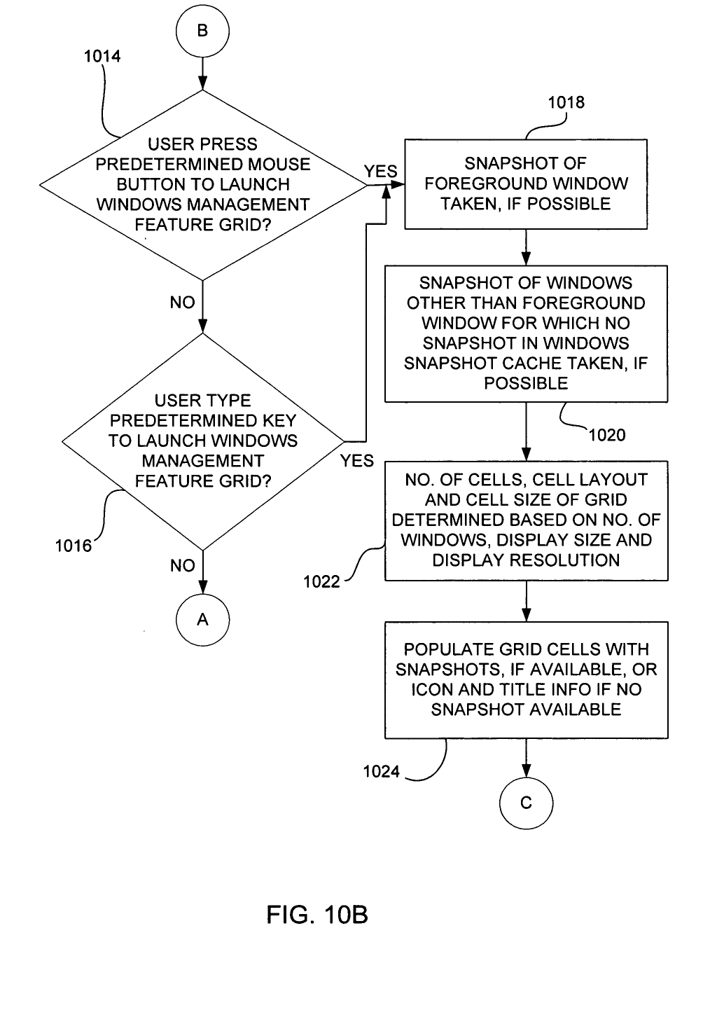

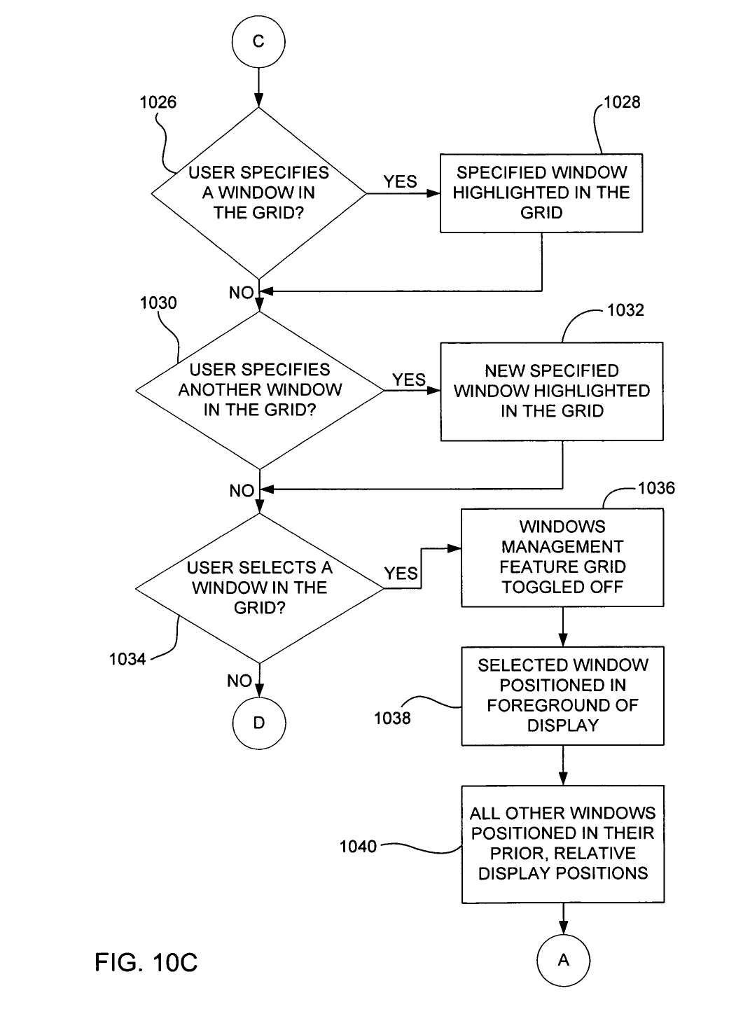

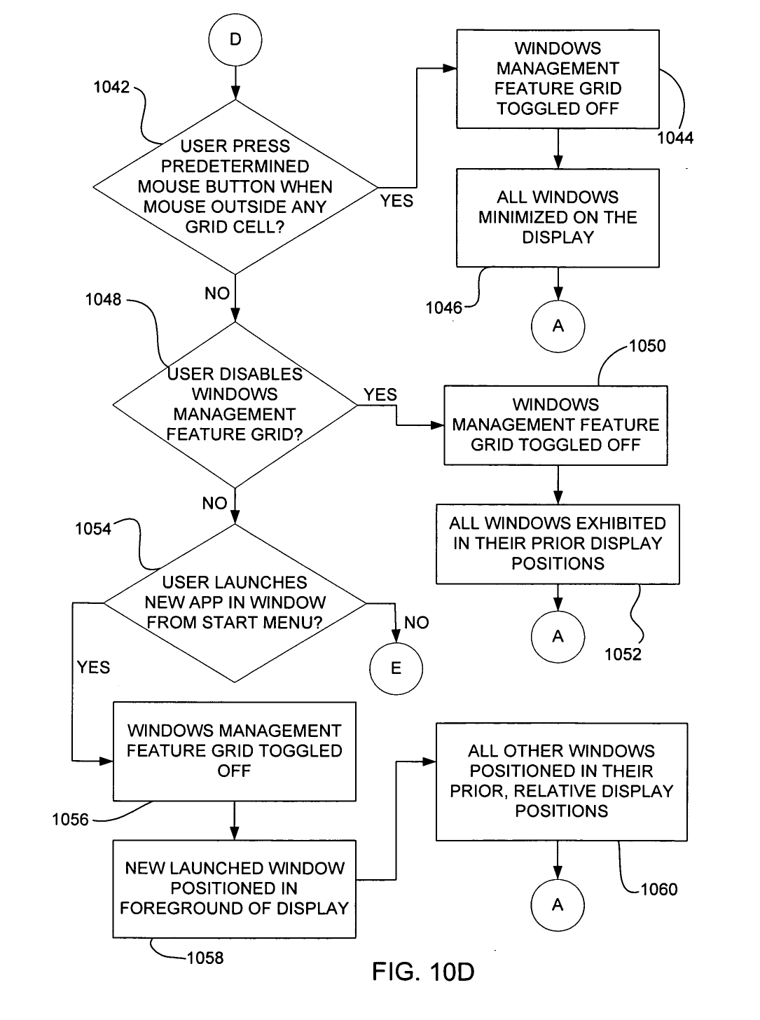

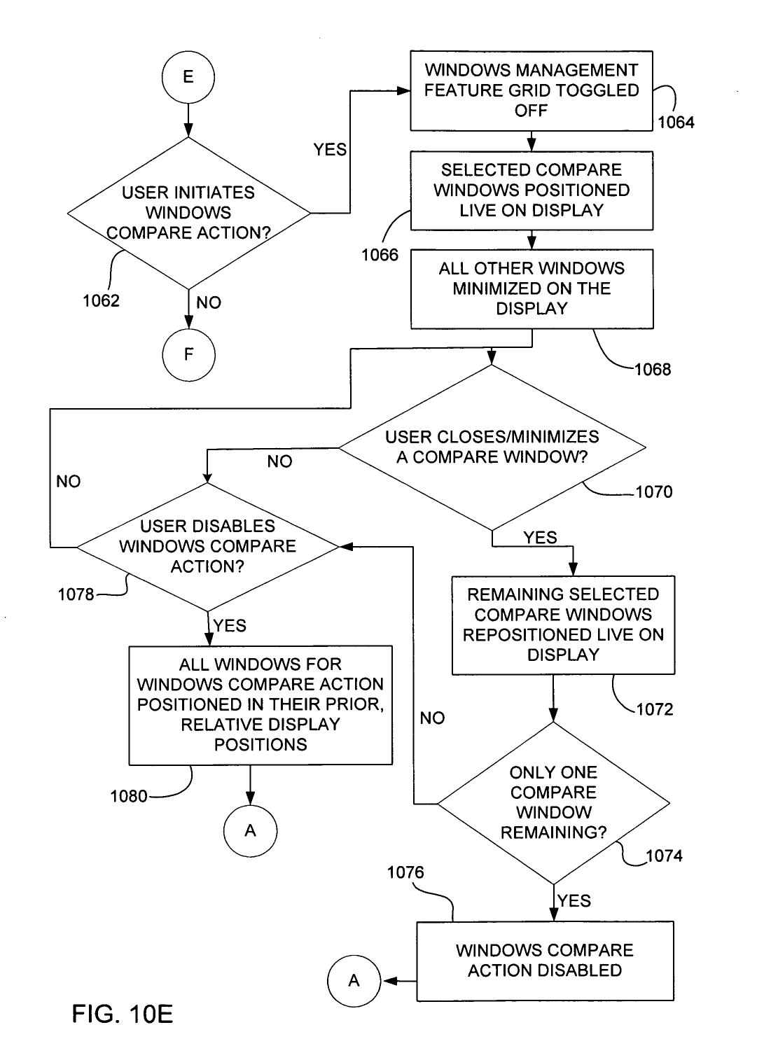

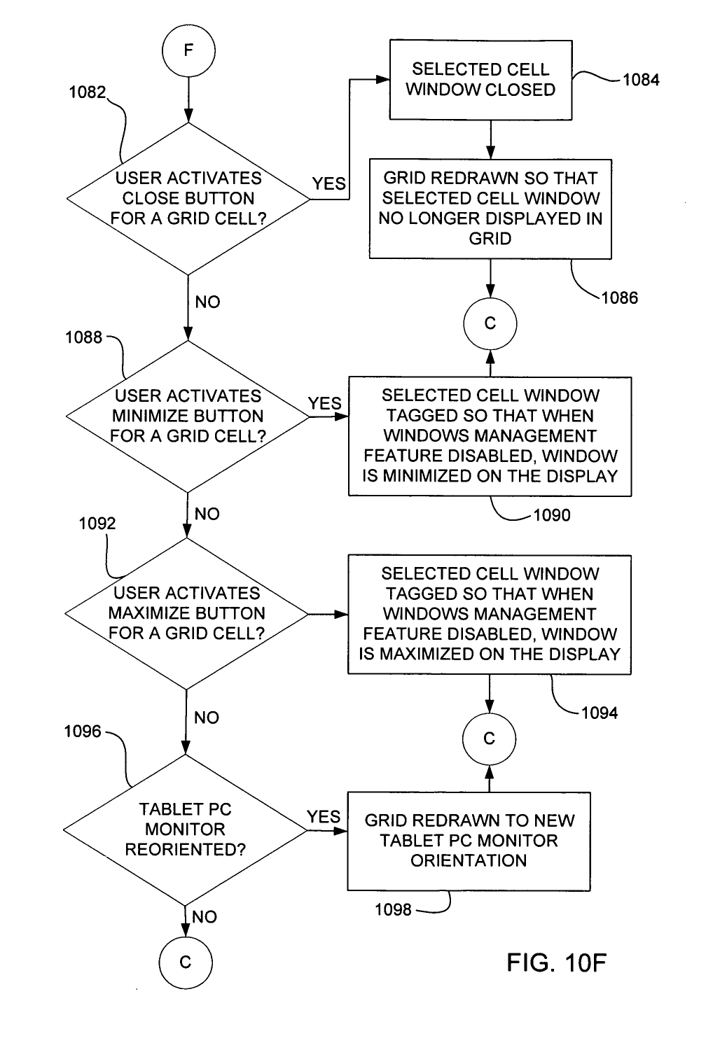

FIGS. 10A-10F show an exemplary logic flow that an embodiment windows management feature follows in generating, managing and dismissing, or otherwise canceling, a windows management feature grid of open windows. While the following discussion is made with respect to systems portrayed herein, the operations described may be implemented in other systems. Further, the operations described herein are not limited to the order shown. Additionally, in other alternative embodiments more or fewer operations may be performed.

At decision block 1002 of FIG. 10A a determination is made as to whether a new application, or application instance, has been launched in a new window on the computing device. If a new application, or application instance, is launched in a new window on the computing device the embodiment windows management feature waits a predetermined time for the new window, and its hosted application, to initialize 1004. After waiting a predetermined time the embodiment windows management feature then determines the icon and title for the newly launched window and stores this information 1006. The embodiment windows management feature takes a snapshot of the newly launched window if possible 1008.

At decision block 1010 a determination is made as to whether the embodiment windows management feature successfully obtained a snapshot of the newly launched window. If yes, the snapshot is stored in a cache, e.g., a windows snapshot cache, 1012.

At decision block 1014 of FIG. 10B a determination is made as to whether a user has pressed a predetermined mouse button to launch, or otherwise enable, an embodiment windows management feature grid. If no, at decision block 1016 a determination is made as to whether a user has typed a predetermined key on the keyboard associated with the computing device to launch, or otherwise enable, an embodiment windows management feature grid. If no, the embodiment windows management feature logic returns to decision block 1002 of FIG. 10A to determine if a new application has been launched in a new window on the computing device.

At decision block 1014 or decision block 1016 of FIG. 10B, if a user has pressed an appropriate mouse button or key to launch an embodiment windows management feature grid, a snapshot of the foreground window is taken if possible 1018. Snapshots of all other open windows that meet predefined criteria and for which no snapshot is stored in the cache are also taken if possible 1020. In an embodiment the predefined criteria requires the open windows be enabled and have the visible property, i.e., are, or would be, visible to a user if not obscured by any other window, and that they not be a tool window or an inactive window.

The embodiment windows management feature determines the number of cells, cell layout and cell size of a grid for displaying all the open windows 1022. In an embodiment the number of cells, cell layout and cell size are determined at least in part by the number of open windows to be displayed in the grid, the computing device display size and the computing device display resolution.

The embodiment windows management feature then populates the grid cells with snapshots of the open windows, if available, or, if no snapshot is available, the icon and title information for the respective open window 1024. In an embodiment the windows management feature populates the grid cells with open window views based on the z-order of the non-minimized windows. In another embodiment the windows management feature populates the grid cells with open window views based on the windows' respective Alt-Tab order, i.e., from the most recently used window to the least recently used window. In yet another embodiment the windows management feature populates grid cells with open window views based on the windows' respective Taskbar order, i.e., from the most recently launched window to the least recently launched window. In still other embodiments, the windows management feature populates grid cells with open window views based on other criteria.

At decision block 1026 of FIG. 10C a determination is made as to whether a user has specified a window whose view is displayed in a grid cell. In an embodiment a user can specify a window by hovering, or otherwise positioning, the computing device mouse over the window view in the grid. In an embodiment a user can specify a window by hovering the computing device pen over the window view in the grid.

In the embodiment windows management feature if a user has specified a window whose view is displayed in a grid cell the specified window's view is highlighted in the grid 1028.

At decision block 1030 a determination is made as to whether a user has specified another windows whose view is displayed in a grid cell. In an embodiment a user can specify another window by moving the computing device mouse to hover over the new window's view in the grid. In an embodiment a user can specify another window by moving the computing device pen to hover over the new window's view in the grid. In an embodiment a user can specify another window by using the scroll wheel on their computing device mouse to move the window specification within the grid. In an embodiment a user can specify another window by using the arrow keys on their computing device keyboard to move the window specification within the grid.

In the embodiment windows management feature if a user has specified another window whose view is displayed in a grid cell the old specified window's view is no longer highlighted and the new specified window's view is highlighted in the grid 1032.

At decision block 1034 a determination is made as to whether a user has selected a window whose view is displayed in a grid cell. In an embodiment a user can select a window by clicking a predetermined mouse button, e.g., the left mouse button on a three-button mouse, while the mouse is positioned on the selected window's grid cell. In an embodiment a user can select a window by clicking the computing device pen while the pen is positioned on the selected window's grid cell. In an embodiment a user can select a currently specified window by typing the “enter” key on the computing device keyboard. In other embodiments a user can select a window via other computing device input actions.

In the embodiment windows management feature if a user selects a window whose view is displayed in a grid cell the windows management feature grid is toggled off 1036. In this embodiment the selected windows is positioned in the foreground, i.e., first in the z-order, of the computing device display, in its original x-y position and with the original size it had before the windows management feature enabled the last grid 1038. In this embodiment all other open windows exhibited in the grid are repositioned in their relative z-order on the computing device display, taking into account that the selected window is positioned in the foreground, in their original x-y positions and with the original sizes they had before the windows management feature enabled the last grid 1040. The embodiment windows management feature logic returns to decision block 1002 of FIG. 10A to determine if a new application has been launched in a new window on the computing device.

At decision block 1042 of FIG. 10D a determination is made as to whether a user has pressed a predetermined mouse button, e.g., the left mouse button, when the computing device mouse is positioned outside of any grid cell. If yes, the embodiment windows management feature grid is toggled off 1044. In this embodiment all open windows displayed in the grid are minimized to respective Taskbar buttons on the computing device display, leaving the desktop showing 1046. The embodiment windows management feature logic returns to decision block 1002 of FIG. 10A to determine if a new application has been launched in a new window on the computing device.

At decision block 1048 a determination is made as to whether a user has performed an action that disables, or otherwise toggles off, the windows management feature grid.

In an embodiment a user clicking on a Taskbar element other than the Taskbar buttons associated with the open windows or the “start” Taskbar button when a grid is displayed causes the grid to toggle off. In an embodiment a user pressing a predetermined mouse button, e.g., the middle mouse button of a three-button computing device mouse when a grid is displayed causes the grid to toggle off. In an embodiment a user pressing a predetermined key on a keyboard when the grid is displayed causes the grid to toggle off. In an embodiment a user typing, or otherwise pressing, the “esc” key on the computing device keyboard when a grid is displayed causes the grid to toggle off. In an embodiment a user typing, or otherwise pressing, the “ALT” and “F4” keys on the computing device keyboard simultaneously when a grid is displayed causes the grid to toggle off. In alternative embodiments other user actions taken when a grid is displayed cause the grid to toggle off.

If a determination is made at decision block 1048 that a user has performed an action that disables, or otherwise toggles off, the windows management feature grid, then the grid is toggled off 1050. In an embodiment the user action causes all open windows displayed in the grid to be exhibited in their prior x-y and z-order positions, with the original size they had before the windows management feature enabled the last grid 1052. The embodiment windows management feature logic returns to decision block 1002 of FIG. 10A to determine if a new application has been launched in a new window on the computing device.

At decision block 1054 a determination is made as to whether a user has launched a new application in a new window from the start menu while a grid is currently being displayed. If yes, the windows management feature grid is toggled off 1056. In an embodiment the new window for the newly launched application is positioned in the foreground of the computing device display 1058. In an embodiment all the open windows whose views were exhibited in the grid are repositioned in their relative z-order on the computing device display, taking into account that the newly launched application window is positioned in the foreground, in their original x-y positions and with the original sizes they had before the windows management feature enabled the last grid 1060. The embodiment windows management feature logic returns to decision block 1002 of FIG. 10A and determines that a new application has been launched in a new window on the computing device.

At decision block 1062 of FIG. 10E a determination is made as to whether a user has initiated a windows compare action. In an embodiment a user initiates a windows compare action by selecting, or otherwise clicking on, the compare buttons in the grid cells for two or more open windows. In an alternative embodiment a user initiates a windows compare action by selecting, or otherwise clicking on, the horizontal compare buttons in the grid cells for two or more open windows. In another aspect of this alternative embodiment a user initiates a windows compare action by selecting, or otherwise clicking on, the vertical compare buttons in the grid cells for two or more open windows.

If a user has initiated a windows compare action then in an embodiment the windows management feature grid is toggled off 1064. The selected windows for the windows compare action are positioned as live windows on the computing device display 1066. In an embodiment all other open windows displayed in the grid that are not selected for the windows compare action are minimized to respective Taskbar buttons on the computing device display 1068.

At decision block 1070 a determination is made as to whether a user has closed or minimized a window selected for a windows compare action. If yes, in an embodiment the remaining selected windows for the windows compare action are repositioned, and appropriately resized, as live windows on the computing device display 1072.

At decision block 1074 a determination is made as to whether there is only one existing window maximized on the computing device display for the windows compare action. If yes, the windows compare action is disabled and the currently maximized window remains as exhibited on the computing device display 1076. The embodiment windows management feature logic returns to decision block 1002 of FIG. 10A to determine if a new application has been launched in a new window on the computing device.

If at decision block 1070 a determination is made that a user has not closed or minimized a window displayed for the windows compare action or if at decision block 1074 a determination is made that there is more than one existing maximized window on the computing device display for the windows compare action, at decision block 1078 a determination is made as to whether a user has disabled the windows compare action. In an embodiment a user disables the windows compare action by pressing a predetermined mouse button while the windows compare action is enabled. In an embodiment a user disables the windows compare action by typing, or otherwise pressing, a predetermined key on the computing device keyboard while the windows compare action is enabled. In other embodiments other user actions disable the windows compare action.

If the user has disabled the windows compare action, in an embodiment all the currently maximized windows for the windows compare action are repositioned in their prior relative z-order and in their original x-y positions on the computing device display, with the original size they had before the windows management feature enabled the last grid 1080. In an alternative embodiment, if a user has disabled the windows compare action, all currently maximized windows for the windows compare action and minimized windows represented by Taskbar buttons are repositioned in their prior relative z-order and in their original x-y positions on the computing device display, with the original size they had before the windows management feature enabled the last grid.

At decision block 1082 of FIG. 10F a determination is made as to whether a user has activated, or otherwise selected, a close button for a grid cell. If yes, the window whose view is displayed in the respective grid cell is closed 1084. In an embodiment the contents of the window are saved prior to the window being closed. In an embodiment the grid is redrawn so that the window that is closed in no longer represented in the grid 1086. The embodiment windows management feature logic returns to decision block 1026 of FIG. 1C where a determination is made as to whether a user has specified a window displayed in the grid.

At decision block 1088 a determination is made as to whether a user has activated, or otherwise selected, a minimize button for a grid cell. If yes, in an embodiment the window whose view is displayed in the respective grid cell, i.e., the selected window, is tagged so that when the windows management feature grid is toggled off the selected window is minimized on the computing device display 1090. The embodiment windows management feature logic returns to decision block 1026 of FIG. 1C where a determination is made as to whether a user has specified a window displayed in the grid.

At decision block 1092 a determination is made as to whether a user has activated, or otherwise selected, a maximize button for a grid cell. If yes, in an embodiment the window whose view is displayed in the respective grid cell, i.e., the selected window, is tagged so that when the windows management feature grid is toggled off the selected window is maximized on the computing device display 1094. The embodiment windows management feature logic returns to decision block 1026 of FIG. 1C where a determination is made as to whether a user has specified a window displayed in the grid.

At decision block 1096 a determination is made as to whether the tablet PC monitor of the computing device, or the monitor of the computing device with tablet PC capabilities, has been reoriented. If yes the grid is redrawn to reflect the new tablet PC monitor orientation 1098.

### Computing Device System Configuration

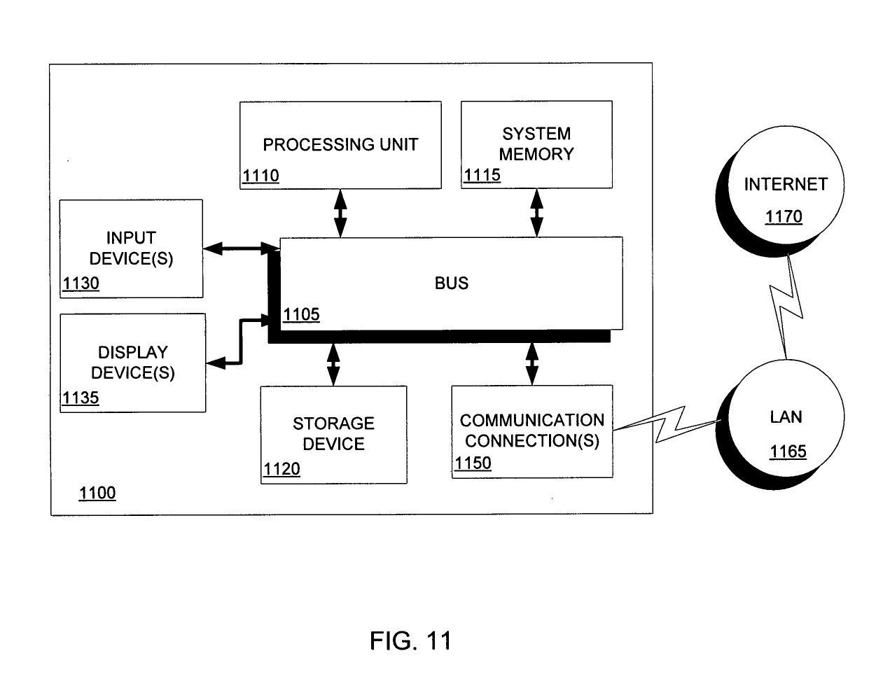

FIG. 11 is a block diagram that illustrates an exemplary computing device system 1100 upon which an embodiment can be implemented. The computing device system 1100 includes a bus 1105 or other mechanism for communicating information, and a processing unit 1110 coupled with the bus 1105 for processing information. The computing device system 1100 also includes system memory 1115, which may be volatile or dynamic, such as random access memory (RAM), non-volatile or static, such as read-only memory (ROM) or flash memory, or some combination of the two. The system memory 1115 is coupled to the bus 1105 for storing information and instructions to be executed by the processing unit 1110, and may also be used for storing temporary variables or other intermediate information during the execution of instructions by the processing unit 1110. The system memory 1115 often contains an operating system and one or more programs, and may also include program data.

In an embodiment, a storage device 1120, such as a magnetic or optical disk, is also coupled to the bus 1105 for storing information, including program code comprising instructions and/or data.

The computing device system 1100 generally includes one or more display devices 1135, such as, but not limited to, a display screen, e.g., a cathode ray tube (CRT) or liquid crystal display (LCD), a printer, and one or more speakers, for providing information to a computing device user. The computing device system 1100 also generally includes one or more input devices 1130, such as, but not limited to, a keyboard, mouse, trackball, pen, voice input device(s), and touch input devices, which a computing device user can utilize to communicate information and command selections to the processing unit 1110. All of these devices are known in the art and need not be discussed at length here.

The processing unit 1110 executes one or more subsequences of one or more program instructions contained in the system memory 1115. These instructions may be read into the system memory 1115 from another computing device-readable medium, including, but not limited to, the storage device 1120. In alternative embodiments, hard-wired circuitry may be used in place of or in combination with software program instructions. Thus, the computing device system environment is not limited to any specific combination of hardware circuitry and software.

The term “computing device-readable medium” as used herein refers to any medium that can participate in providing program instructions to the processing unit 1110 for execution. Such a medium may take many forms, including but not limited to, storage media and transmission media. Examples of storage media include, but are not limited to, RAM, ROM, EEPROM, flash memory, CD-ROM, digital versatile disks (DVD), magnetic cassettes, magnetic tape, magnetic disk storage, or any other magnetic medium, floppy disks, flexible disks, punch cards, paper tape, or any other physical medium with patterns of holes, memory chip, or cartridge. The system memory 1115 and storage device 1120 of the computing device system 1100 are further examples of storage media. Examples of transmission media include, but are not limited to, wired media such as coaxial cable(s) and copper wire, and wireless media such as fiber optic signals, acoustic signals, RF signals and infrared signals.

The computing device system 1100 also includes one or more communication connections 1150 coupled to the bus 1105. The communication connection(s) 1150 provide a two-way data communication coupling from the computing device system 1100 to other computing devices on a local area network (LAN) 1165 and/or wide area network (WAN), including the World Wide Web, or Internet 1170. Examples of the communication connection(s) 1150 include, but are not limited to, an integrated services digital network (ISDN) card, modem, LAN card, and any device capable of sending and receiving electrical, electromagnetic, optical, acoustic, RF or infrared signals.

Communications received by the computing device system 1100 can include program instructions and program data. The program instructions received by the computing device system 1100 may be executed by the processing unit 1110 as they are received, and/or stored in the storage device 1120 or other non-volatile storage for later execution.

### CONCLUSION

While various embodiments are described herein, these embodiments have been presented by way of example only and are not intended to limit the scope of the claimed subject matter. Many variations are possible which remain within the scope of the following claims. Such variations are clear after inspection of the specification, drawings and claims herein. Accordingly, the breadth and scope of the claimed subject matter is not to be restricted except as defined with the following claims and their equivalents.

What is claimed is:

1. A method for windows management on a computing device comprising a computing device display, the method comprising:
taking a first window snapshot of a first newly launched application window a predetermined time after the first application window is launched;
storing the first window snapshot;
taking a second window snapshot of a second newly launched application window the predetermined time after the second application window is launched;
storing the second window snapshot;
receiving a user command to display all open application windows;
taking a current snapshot of the application window that is positioned in the foreground of the computing device display after receiving the user command to display all open application windows; and
generating a grid of two or more cells on the computing device display wherein the current snapshot is displayed in one cell of the grid and each window snapshot that is stored for an application window other than the application window positioned in the foreground of the computing device display is displayed in a cell of the grid and wherein no cell in the grid overlaps any other cell in the grid.

2. The method for windows management on a computing device of claim 1 wherein the predetermined time is five seconds.

3. The method for windows management on a computing device of claim 1 wherein the first window snapshot and the second window snapshot are stored in a cache for the computing device.

4. The method of windows management on a computing device of claim 1, further comprising:
gathering the icon and title information for the first newly launched application window;
storing the icon and title information for the first newly launched application window;
gathering the icon and title information for the second newly launched application window; and
storing the icon and title information for the second newly launched application window.

5. The method of windows management on a computing device of claim 1 wherein the user command to display all open application windows is a single mouse button click.

6. The method of windows management on a computing device of claim 1, further comprising:
gathering the icon and title information for a third newly launched application window;
storing the icon and title information for the third newly launched application window;
attempting to take a snapshot of the third newly launched application window; and
displaying the icon and title information for the third newly launched application window in a cell of the grid when the attempt to take the snapshot of the third newly launched application window fails.

7. The method of windows management on a computing device of claim 1, further comprising:
receiving a user command to disable the grid; and
disabling the grid and returning the application window positioned in the foreground of the computing device display before the grid was generated to the foreground of the computing device display in the same x-y position the application window occupied on the computing device display prior to the grid being generated.

8. The method of windows management on a computing device of claim 1, further comprising:
receiving a user command to compare two or more selected open application windows;
minimizing all open application windows that are not selected for the compare of two or more selected open application windows; and
displaying each selected open application window as a live window on the computing device display simultaneously, wherein no live window overlaps any other live window displayed on the computing device display for the compare of two or more selected open application windows.

9. A method for displaying views of two or more open windows simultaneously and unobscured on a computing device comprising a computing device display, the method comprising:
taking a window snapshot of a first window launched on the computing device as an open window;
storing the window snapshot of the first window;
taking a window snapshot of a second window launched on the computing device as an open window;
storing the window snapshot of the second window;
receiving a first user command to display all windows simultaneously;
populating a grid of two or more cells on the computing device by displaying a view of each open window on the computing device in a cell of the grid wherein no cell of the grid overlaps any other cell of the grid and wherein the view of one open window displayed in a cell of the grid is the stored window snapshot for the one open window;
receiving a second user command to disable the grid; and
disabling the grid and returning all open windows to the x-y positions they occupied on the computing device display prior to the grid being populated with a view of each open window.

10. The method for displaying views of two or more open windows simultaneously and unobscured on a computing device of claim 9 wherein the first user command to display all windows simultaneously is a mouse button click and wherein the second user command to disable the grid is a mouse button click.

11. The method for displaying views of two or more open windows simultaneously and unobscured on a computing device of claim 9 wherein the view of a second open window displayed in a cell of the grid is the live second open window.

12. The method for displaying views of two or more open windows simultaneously and unobscured on a computing device of claim 9, further comprising taking a current snapshot of the window displayed in the foreground of the computing device display when the first user command to display all windows simultaneously is received and wherein the view of a second open window displayed in a cell of the grid is the current snapshot.

13. The method for displaying views of two or more open windows simultaneously and unobscured on a computing device of claim 9 wherein the window snapshot of the first window launched on the computing device as an open window is taken a predetermined time after the first window is launched, and wherein the window snapshot of the second window launched on the computing device as an open window is taken the predetermined time after the second window is launched.

14. The method for displaying views of two or more open windows simultaneously and unobscured on a computing device of claim 9 wherein the window that was in the foreground on the computing device display when the first user command to display all windows simultaneously was received is repositioned in the foreground on the computing device display when the grid is disabled.

15. The method for displaying views of two or more open windows simultaneously and unobscured on a computing device of claim 9, further comprising:
receiving a third user command to disable the grid wherein a view of a window displayed in a cell of the grid is selected and wherein the window whose view is selected was not positioned in the foreground of the computing device display prior to the grid being populated with a view of each open window;
disabling the grid;
returning all open windows to the x-y positions they occupied on the computing device display prior to the grid being populated with a view of each open window when the grid is disabled; and
repositioning the window whose view is selected to the foreground of the computing device display when the grid is disabled.

16. The method for displaying views of two or more open windows simultaneously and unobscured on a computing device of claim 9, further comprising:
receiving a third user command to compare two or more windows whose views are selected when the views are populating the grid;
minimizing all open windows whose views populate the grid and whose views are not selected when the third user command to compare two or more windows is received; and
displaying each window whose view is selected when the third user command to compare two or more windows is received as a live window on the computing device display simultaneously, wherein no live window overlaps any other live window displayed on the computing device display for the compare of two or more windows.

17. A method for windows management on a computing device comprising a computing device display, the method comprising:
taking a window snapshot of a first newly launched window on the computing device;
storing the window snapshot for the first newly launched window;
taking a window snapshot of a second newly launched window on the computing device;
storing the window snapshot of the second newly launched window;
receiving a first user command to display all open windows;
generating a grid of one or more cells on the computing device display wherein at least one stored window snapshot is displayed in one cell of the grid and wherein no cell in the grid overlaps any other cell in the grid;
receiving a second user command to toggle the grid off; and
disabling the grid and returning all windows whose snapshot is displayed in a cell of the grid to the x-y positions they occupied on the computing device display prior to the grid being generated.

18. The method for windows management on a computing device of claim 17 wherein the window snapshot of the first newly launched window on the computing device is taken a set time after the first window is launched and wherein the window snapshot of the second newly launched window on the computing device is taken the set time after the second window is launched.

19. The method for windows management on a computing device of claim 18 wherein the set time is no less than five seconds.

20. The method for windows management on a computing device of claim 17 wherein the first user command to display all open windows is a single action command and wherein the second user command to toggle the grid off is a single action command.
